(19) United States
(12) Patent Application Publication
(10) Pub. No.: US 2025/0312750 A1
(43) Pub. Date: Oct. 9, 2025

(54) SELECTIVE MEMBRANES FOR METAL RECOVERY AND METHOD OF USE

(71) Applicant: Arrowhead Center, Inc., Las Cruces, NM (US)

(72) Inventors: Huiyao Wang, Las Cruces, NM (US); Xiaochun Yin, Las Cruces, NM (US); Pei Xu, Las Cruces, NM (US)

(73) Assignee: Arrowhead Center, Inc., Las Cruces, NM (US)

(21) Appl. No.: 19/170,815

(22) Filed: Apr. 4, 2025

Related U.S. Application Data
(60) Provisional application No. 63/575,528, filed on Apr. 5, 2024.

(51) Int. Cl. B01D 71/60; B01D 67/00; B01D 69/10; C02F 1/44; C02F 101/10; C22B 3/42; C22B 26/10; C22B 26/12; C22B 26/22

(52) U.S. Cl. CPC B01D 71/601; B01D 67/0006; B01D 69/107; C02F 1/44; C22B 3/42; C22B 26/10; C22B 26/12; C22B 26/22; C02F 2101/10

(57) ABSTRACT

A selective membrane for selectively removing a metal ion from a solution. The selective membrane comprises a substrate, a polyethyleneimine layer comprising a crown ether and a cross-linker, and a polydopamine layer. A method for manufacturing a selective membrane. The method comprises contacting a substrate with polydopamine, forming a polydopamine layer on the surface of the substrate, contacting the polydopamine layer with polyethyleneimine, a cross-linker, and a crown ether, forming a polyethyleneimine layer comprising the crown ether and the cross-linker, and forming an ion channel with the crown ether. A method for selectively removing a metal ion from a solution. The method comprises contacting the solution comprising a metal with a selective membrane, applying an electric field to the selective membrane, and passing the metal ion through an ion channel.

### CROSS-REFERENCE TO RELATED APPLICATIONS

This application claims priority to and the benefit of the filing of U.S. Provisional Patent Application No. 63/575,528, entitled “SELECTIVE MEMBRANES FOR METAL RECOVERY AND METHOD OF USE,” filed on Apr. 5, 2024.

### BACKGROUND OF THE INVENTION

### Field of the Invention (Technical Field)

The present inventions relates to selective membranes for metal recovery, e.g., lithium, sodium, potassium, magnesium, and a method of using the membrane for metal recovery.

### Background

Lithium, a fundamental element in the evolving energy landscape, has garnered increasing attention due to its role in powering electric vehicles and driving advancements in battery technologies. Beyond its application in battery production, lithium holds significance in various industries, such as lubricating grease production, primary aluminum, ceramics, and glass, owing to its diverse and unique properties. The increased demand for lithium stems from the rapid growth of portable electronic devices and electric vehicles, positioning lithium as the pivotal “energy element” of the 21st century. In 2023, global lithium consumption surged to 180,000 tons, a substantial 27% increase from 2022 (145,000 tons) in response to strong demand from the lithium-ion battery market, while the average annual U.S. lithium carbonate price in 2023 reached $46,000 per ton, higher than that in 2022 ($37,000 per ton). The escalating global demand for lithium has underscored the need for lithium supply. To address this concern, there has been a concerted effort to establish secure and diversified supply chains. Therefore, the development of effective technologies for the selective recovery of lithium emerges as a resolution.

The escalating demand for lithium, a vital component in batteries and electronic devices, notably within the expanding field of electromobility, has spurred intensified research efforts on lithium recovery. Given its strategic significance in portable electronics and battery electric vehicles (“BEVs”), there has been an exponential surge in global demand. However, the existing constraints in lithium availability and the environmental challenges associated with conventional extraction methods highlight a compelling need for alternative approaches to lithium recovery. Despite the abundance of lithium reservoirs in brine and seawater, the low concentration and the intricacies of selectively separating lithium from competing metal ions such as Na⁺ and Mg²⁺ pose substantial challenges. Projections indicate a potential shortfall in lithium supply in the future, emphasizing the need for lithium recovery technologies.

To date, technologies have focused on the separation and recovery of lithium from brine, recognizing the significant presence of high-grade lithium brines in current commercial lithium extraction operations. The predominant methods for lithium separation and recovery include chemical precipitation, solvent extraction, adsorption, and electrodialysis. Chemical precipitation and solvent extraction methods involve substantial quantities of chemicals and solvents, whereas the adsorption method typically necessitates intricate post-processing procedures. In contrast, electrodialysis presents distinct advantages, such as scalability, compact footprint, and weather independence, positioning membrane-based processes viable for industrial applications. Electrodialysis is a process using ion-exchange membranes to separate salt ions from a solution using an electric field which finds applications in water purification, desalination, and the recovery of metals from industrial waste streams. The process involves passing the brine solution through selective, permeable membranes in a sequence designed to target specific ions. However, achieving the necessary cation selectivity for Li⁺ over other cationic ions like Na⁺ and Mg²⁺ poses a challenge, particularly for the monovalent ions due to the lack of selectivity of the cation exchange membrane (“CEM”) for lithium ions. Therefore, enhancing the permselectivity of CEM for Li⁺ is important in recovering lithium from brine through electrodialysis.

In comparison to traditional methods of ion separation, such as adsorption and/or desorption, electrochemical extraction, and solvent extraction, electrodialysis emerges as an efficient approach for the recovery of lithium from brines because there is no need to use additional chemicals and due to its simplicity of operation. Electrodialysis is an electro-driven membrane technology that exhibits distinct advantages in diverse applications, including salt production, desalination, metal resource extraction from brines, and treatment of industrial and municipal wastewater. Despite its primary application in water desalination, electrodialysis is readily adaptable to lithium recovery from brines or geothermal fluids. The fundamental principle of electrodialysis involves the transport of ions through ion exchange membranes (“IEMs”) under the influence of an electrical potential difference, serving as the driving force for mass transfer. However, it is challenging to develop high-performing, advanced IEMs to effectively separate Li⁺ from co-ions (e.g., Na⁺) with similar structures and properties. In brines, Li⁺ typically coexists with other alkali metal and alkali earth metal ions, such as Na⁺ and Mg²⁺, at significantly higher concentrations than Li⁺. Standard membranes encounter challenges in achieving the selective extraction of Li⁺, particularly due to the chemical properties of coexisting ions Na⁺ and Mg²⁺, like that of Li⁺. Despite the application of special-grade membranes, characterized by a high separation coefficient in the Mg²⁺/Li⁺ separation, challenges persist in separating Na⁺/Li⁺, where the separation coefficient diminishes to values below 1 as the concentration of Na⁺ increases. This underscores that the membrane selectivity towards Li⁺ over co-existing ions such as Na⁺ and Mg²⁺ is important in lithium recovery from brines.

Membranes possessing specific functionalities have garnered increasing attention due to their unique attributes. Enhancing the permselectivity of CEM for monovalent cations typically hinges on three physicochemical phenomena: pore size sieving, electrostatic repulsion, and specific interaction effects. Regarding the pore-size sieving effect, key strategies involve elevating the cross-linking degree and establishing hydrophilic and/or hydrophobic segregated structures within the membrane matrix. Surface modification, widely acknowledged as a facile and efficient method, is an effective approach for crafting membranes selectively permeable to monovalent cations.

A promising method is incorporating ligands, such as a crown ether (“CE”), to form host-guest complexes with specific metal ions based on the dimensions of the CE cavity and metal ion. CEs, large-ring organic compounds with a polyether structure, possess a nanoscale cavity structure, enabling them to bind specific metal ions and form stable complexes through electrostatic interactions, providing channels for specific ions. Furthermore, crown ethers show high promise for selective alkali metals separation due to ionic dipole interactions between positively charged metallic ions and electron-rich oxygen atoms, facilitating their selective binding to specific cations.

CEs, which act as host molecules, have been widely integrated into polymers as functional group anchors for various membrane-based separation applications. CEs exhibit exceptional complexing affinity towards alkali metal and alkali earth metal ions, forming complexes through ion-dipole interactions involving negatively charged oxygen atoms and metal ions positioned within the central region of the CE ring. Crown ethers have been used to prepare membranes for efficient Li⁺ and Mg²⁺ separation. 12-crown-4 ether (“12CE”) (cavity diameter 1.2 Å to 1.5 Å), 14-crown-4 ether (“14CE”) (cavity diameter 1.2 Å to 1.5 Å), 15-crown-5 ether (“15CE”) (cavity diameter 1.7 Å to 2.2 Å), and 18-crown-6 ether (“18CE”) (cavity diameter 2.6 Å to 3.2 Å), all feature polyether structures with pore dimensions that can selectively separate Li⁺. A singular species of CE has been employed either in modifying or preparing membranes to enhance Li⁺ recovery efficiency. Alternatively, membranes prepared with CEs have been used as Li recovery adsorbents.

Given the closely analogous ionic radii and chemical properties of cationic alkali metals, various crown ethers can establish complexes with multiple ions, displaying diverse degrees of stability. To optimize the performance of modified membranes, selecting a crown ether with a discernible reactivity toward the target ion of interest is important. Complex formation constants (known as stability constants) demonstrated the instability of lithium and 15CE complexes in aqueous environments compared to Na⁺ and K⁺, which can form stable complexes. Moreover, 15CE exhibits a higher degree of selectivity for the separation of Li⁺ ions compared to Mg²⁺ ions. As compared to the substantial studies on extracting Li from solutions containing multivalent ions like Co, Ni, Mn, and Mg, there are limited reported studies on the selective separation of Li over Na via electrodialysis, which is typically the dominating ion in brine.

Consequently, with the accelerating demand for lithium, particularly with the widespread integration of lithium-ion batteries in diverse applications, what is needed are highly selective, cost-efficient, and environmentally sustainable methods for lithium recovery from alternative sources. What is needed is a membrane comprising a crown ether that has a higher degree of selectivity for the separation of Li ions compared to both Mg and Na ions.

### BRIEF SUMMARY OF THE INVENTION

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a diagram showing a process flow for lithium recovery, according to an embodiment of the present invention;

FIG. 2 is a diagram showing the modification process of a CR671 membrane, according to an embodiment of the present invention;

FIG. 3 is a diagram showing Li⁺ separation mechanism of electrodialysis, according to an embodiment of the present invention;

FIGS. 4A, 4B, 4C, 4D, 4E, and 4F are graphs showing the characterization of modified membranes and unmodified membranes, according to an embodiment of the present invention;

FIG. 5 is a graph showing water uptake of modified and unmodified membranes, according to an embodiment of the present invention;

FIGS. 6A, 6B, 6C, 6D, 6E, 6F, 6G, and 6H are graphs showing impedance spectra of CR671 and modified membranes, according to an embodiment of the present invention;

FIGS. 7A and 7B are graphs showing impedance spectra of 15-crown-5 ether and polyethyleneimine-polydopamine-CR671 (“15CE-PEI-PDA-CR671”) membranes for different concentration solutions, according to an embodiment of the present invention;

FIGS. 8A and 8B are graphs showing permselectivity improvement and Li flux improvement of membranes in a mixture of MgCl₂ and LiCl, according to an embodiment of the present invention;

FIGS. 9A and 9B are graphs showing permselectivity improvement and Li flux improvement of the membranes in a mixture of NaCl and LiCl, according to an embodiment of the present invention;

FIGS. 10A, 10B, 10C, and 10D are graphs showing permselectivity and Li flux improvement of the membranes in the mixture of Mg and Li, and Na and Li, according to an embodiment of the present invention;

FIG. 11 is a graph showing a process flow for lithium recovery using a crown ether, according to an embodiment of the present invention;

FIG. 12 is a series of graphs showing process of modification of modified membranes, according to an embodiment of the present invention;

FIG. 13 is a graph showing Li⁺ separation mechanism of selective membranes via electrodialysis, according to an embodiment of the present invention;

FIGS. 14A, 14B, 14C, 14D, 14E, and 14F are graphs showing the bond plots in the lower concentration solutions, according to an embodiment of the present invention;

FIGS. 15A, 15B, 15C, and 15D are graphs showing the bond plots in the higher concentration solutions, according to an embodiment of the present invention;

FIGS. 16A, 16B, 16C, and 16D are graphs showing characterization of modified membranes with CEs, according to an embodiment of the present invention;

FIG. 17 is a graph showing water uptake of modified membranes in deionized water, according to an embodiment of the present invention;

FIGS. 18A and 18B are graphs showing the comparison of permselectivity and Li⁺ flux improvement of the three modified membranes, according to an embodiment of the present invention;

FIGS. 19A and 19B are graphs showing permselectivity and Li⁺ flux improvement of membranes in Mg²⁺/Li⁺ brines, according to an embodiment of the present invention; and

FIG. 20 is a table showing lithium recovery performance and permselectivity according to an embodiment of the present invention.

### DETAILED DESCRIPTION OF THE INVENTION

Embodiments of the present invention relate to a membrane for selectively extracting a metal ion from a solution comprising: a substrate, a polyethyleneimine layer comprising a crown ether and a cross-linker, a polydopamine layer, said layer of polydopamine disposed between said polyethyleneimine layer and said substrate. The substrate may comprise a cross-linked copolymer comprising sulfonic acid functional groups. The metal may be lithium. The membrane may be modified to facilitate effective metal extraction from a solution. The membrane may comprise a two-layer coating to enhance metal transport. The membrane may comprise a CR671 membrane. The membrane may comprise a zeta potential of about 40 mV to about 100 mV. The membrane may comprise 12-crown-4 ether, 15-crown-5 ether, and/or 18-crown-6 ether. The membrane may be selective and may be a cation exchange membrane. The membrane may comprise an ion channel. The ion channel may be formed by a crown ether. The cross-linker may comprise 1,3,5-benzenetricarbonyl trichloride. 15CE-PEI-PDA-CR671 may show superior permselectivity and Li⁺ flux improvement compared to traditional lithium-selective membranes. 15CE-PEI-PDA-CR671 may achieve greater Li⁺ recovery in Na⁺/Li⁺ than in Mg²⁺/Li⁺ brine. The 15CE-PEI-PDA-CR671 membrane may significantly enhance metal permselectivity and flux through the membrane compared to other metal-selective membranes. The membrane may recover up to 90% of metal from a solution. The membrane may selectively extract Li⁺ over Na⁺ and/or Mg²⁺ ions and may recover Li⁺ from Na⁺/Li⁺ and Mg²⁺/Li⁺ solutions.

Embodiments of the present invention relate to a method of manufacturing a membrane to enhance the selectivity and capacity of metal ion transport in cation exchange membranes, the method comprising: contacting a substrate with polydopamine, forming a polydopamine layer on the surface of the substrate, contacting the polydopamine layer with polyethyleneimine, a cross-linker, and a crown ether, forming a polyethyleneimine layer comprising the crown ether and the cross-linker, and forming an ion channel with the crown ether. The substrate may comprise a cross-linked copolymer comprising sulfonic acid functional groups. The crown ether may comprise a 15-crown-5 ether. The cross-linker may comprise 1,3,5-benzenetricarbonyl trichloride. The polyethyleneimine and crown ether may be attached to the cross-linker. The method may comprise contacting a two-layer coating of polydopamine and polyethyleneimine, with the addition of crown ether with a cation exchange membrane. The coating may form ion channels to facilitate metal ion transport from a solution.

Embodiments of the present invention relate to a method for selectively removing a metal ion from a solution comprising the metal ion, the method comprising: contacting the solution comprising a metal with a selective membrane; the selective membrane comprising: a substrate, a polyethyleneimine layer comprising a crown ether and a cross-linker, and a polydopamine layer; applying an electric field to the selective membrane; and passing the metal ion through an ion channel. The metal ion may comprise lithium. The metal ion may comprise sodium. The metal ion may comprise magnesium. The method may further comprise passing the metal ion through the polydopamine layer. The crown ether may comprise a 15-crown-5 ether. The cross-linker may comprise 1,3,5-benzenetricarbonyl trichloride. The ion channel may be formed by the crown ether.

Selective extraction of metal ions from highly saline solutions is challenging due to the presence of competing ions like Mg²⁺ and Na⁺. The membrane may selectively extract metal ions from highly saline solutions, addressing challenges associated with the presence of competing ions, such as Mg²⁺ and Na⁺. The membrane may comprise by applying two layers of coating via interfacial polymerization to a cation exchange membranes (“CEM”), e.g., CR671. The layers may comprise polydopamine (“PDA”) and polyethyleneimine (“PEI”) with 15-crown-5 ether (“15CE”). The resulting 15CE-PEI-PDA-CR671 membrane may demonstrate reduced impedance for Li transport, positive surface charge for improved electrostatic repulsion of divalent cations, and heightened selectivity compared to conventional technologies. The coatings, positive surface charge, and/or increased permeability may improve selectivity of metal ions. Potential applications encompass lithium recovery processes, energy storage systems, brine treatment, and/or industrial separation processes.

The terms “Na⁺/Li⁺” and “Mg²⁺/Li⁺” as used herein mean solutions comprising Na⁺ and Li⁺, and Mg²⁺ and Li⁺, respectively.

The term “permselectivity” as used herein means a measure of the ability of a membrane to separate different ions including co-ions, counter-ions, anions, and cations.

The term “metal” or “metals” is defined in the specification and claims as a compound, mixture, or substance comprising a metal atom. The term “metal” or “metals” includes, but is not limited to, metal hydroxides, metal oxides, metal salts, elemental metals, metal ions, non-ionic metals, minerals, or a combination thereof. The metal may comprise a monovalent or divalent ion.

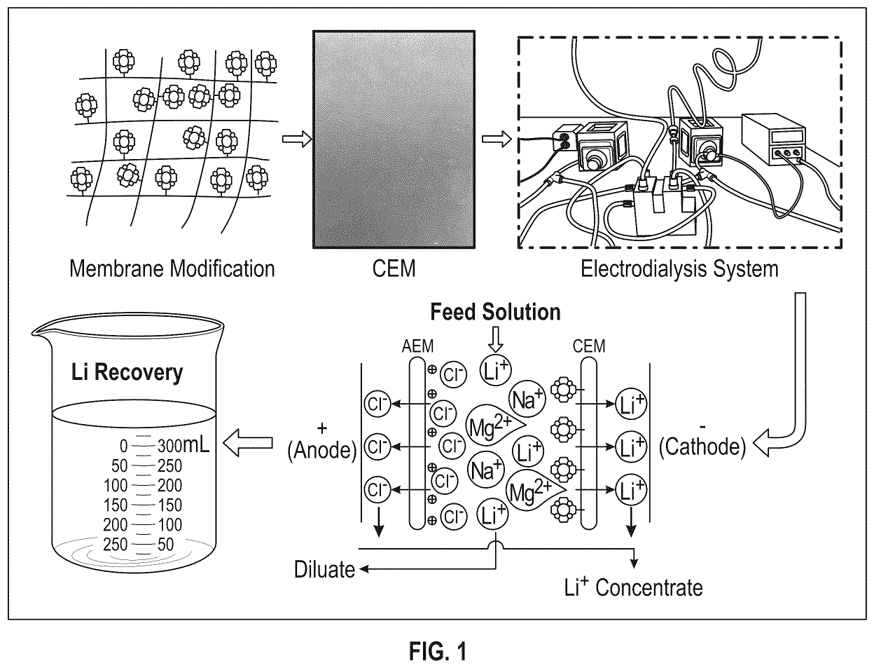

Turning now to the figures, FIG. 1 shows a process flow for lithium recovery.

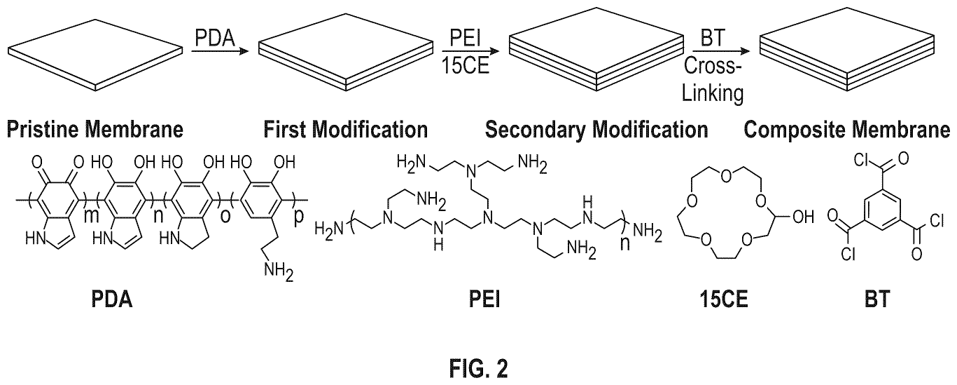

FIG. 2 shows the modification process of a CR671 membrane.

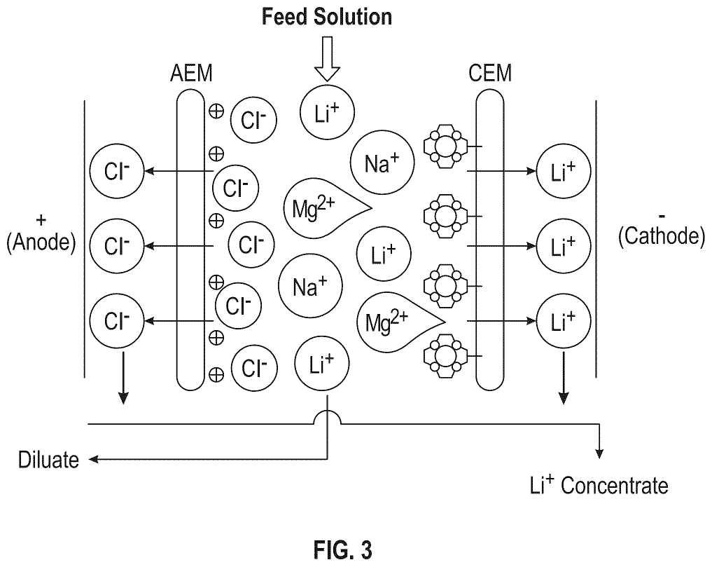

FIG. 3 shows Li⁺ separation mechanism of electrodialysis.

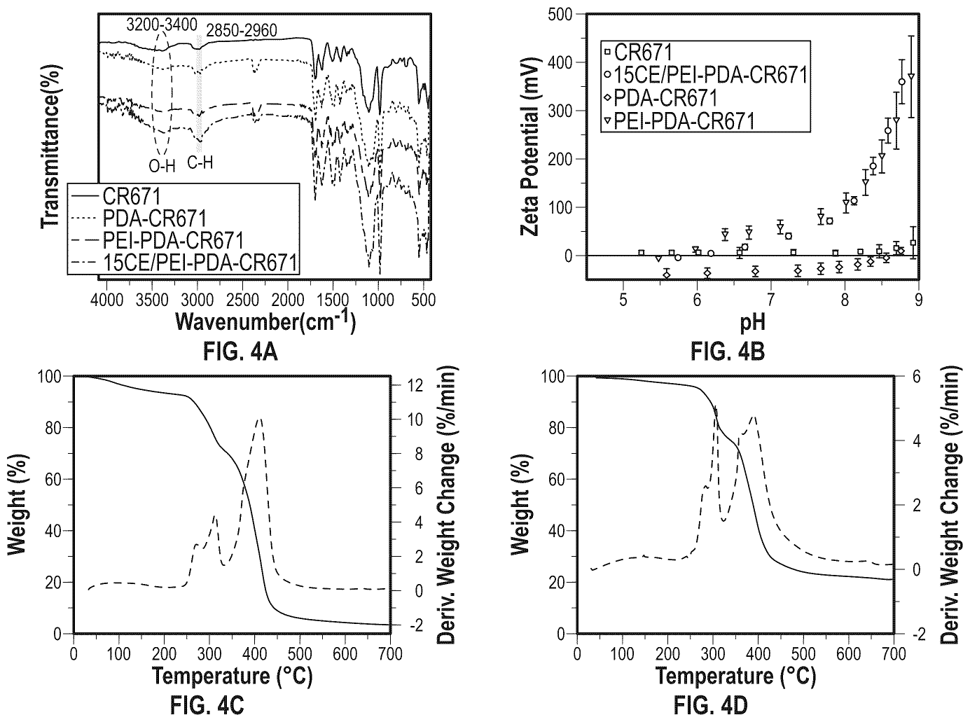

FIGS. 4A, 4B, 4C, 4D, 4E, and 4F show the characterization of modified membranes and unmodified membranes. FIG. 4A shows the ATR-FTIR of modified membranes and unmodified membranes. FIG. 4B shows the zeta potential of modified membranes and unmodified membranes. FIG. 4C shows the TGA of CR671. FIG. 4D shows the TGA of PDA-CR671. FIG. 4E shows the TGA of PEI-PDA-CR671. FIG. 4F shows the TGA of 15CE/PEI-PDA-CR671. The ATR-FTIR is used to characterize the chemical composition of CR671, PDA-CR671, PEI-PDA-CR671, and 15CE/PEI-PDA-CR671 membranes, as shown in FIG. 4A. The peaks within the range of 3200 cm⁻¹ to 3600 cm⁻¹ are attributed to O—H stretching vibrations. In 15CE/PEI-PDA-CR671, the peaks exhibit intensity owing to the presence of hydroxymethyl (—CH₂OH) groups in 15CE, contributing to the FTIR spectrum. The peaks observed at 2850 cm⁻¹ to 2960 cm⁻¹ correspond to C—H stretching vibrations, with heightened intensity resulting in 15CE/PEI-PDA-CR671 from the incorporation of 15CE. The prominent nature of these peaks indicates the presence of crown ether on the 15CE/PEI-PDA-CR671 surface.

Zeta potential regulates interactions among charged surfaces in water and mirrors the electrochemical traits of membrane surfaces, impacting the sorption of ions. This sorption is contingent on factors such as membrane composition and the types of electrolytes used, with pH playing a role in zeta potential modulation through ion sorption. In electrodialysis for lithium recovery, zeta potential dictates ion selectivity and transport characteristics crucial for membrane based processes. The results of the zeta potential of membranes are shown in FIG. 4B. The CR671 membrane demonstrates a positive charge (5.2 mV) within the pH range of 5 to 7, indicative of a slightly acidic to neutral environment. The membranes (PDA-CR671) modified with PDA exhibit a negatively charged surface, ranging from −41.3 mV to −4.5 mV within the pH range of 5 to 8.6. This negativity stems from the deprotonation of amine and phenolic hydroxyl groups, as the isoelectric point of PDA is 4. The PEI coating layer polymerized with BT on both membranes (PEI-PDA-CR671 and 15CE/PEI-PDA-CR671, displaying similar zeta potentials) results in a positively charged surface. Within the pH range of 5 to 7, the zeta potentials remain consistently within the range of 43 mV to 100 mV. When the pH exceeded 8 to 9, the zeta potentials increase to approximately 360 mV. In the case of 15CE/PEI-PDA-CR671 membranes, the introduction of 15CE does not exert a significant influence on the zeta potential of the membranes. This positive charge is ascribed to the cationic nature of PEI with a pKa of 7 and its prominently branched structure. Consequently, despite the incorporation of 15CE, the zeta potential of 15CE/PEI-PDA-CR671 remains comparable to that of PEI-PDA-CR671. This suggests that surface charge may not be the primary factor contributing to the differences in ion transport rates between 15CE/PEI-PDA-CR671 and PEI-PDA-CR671 membranes.

In FIGS. 4C, 4E, and 4F, thermogravimetric analysis (“TGA”) is employed to characterize the membrane properties. The weight loss characteristics of the samples is examined over a temperature range of 35° C. to 700° C., revealing distinct phases at 35° C. to 280° C., 280° C. to 320° C., 320° C. to 430° C., and 430° C. to 700° C. The initial weight loss phase may be primarily attributed to the evaporation of water inherent to the samples or the elimination of residual absorbed water. The pronounced initial weight loss observed between 280° C. to 320° C. is associated with the molecular chain cleavage of the polymer in the CR671. Subsequently, in the second rapid weight loss phase (320° C. to 430° C.), the polymer undergoes a gradual decomposition process. A stable sample weight characterizes the final stage. For CR671, the membranes experience complete decomposition, leaving only 3.5% of the initial sample weight, indicating the susceptibility of these samples to thermal decomposition with increasing temperature. Following modification, at the ultimate stage, the membranes (PDA-CR671, PEI-PDA-CR671, and 15CE/PEI-PDA-CR671) exhibit approximately 22% retained weight, signifying enhanced thermal stability compared to the unmodified CR671 membranes.

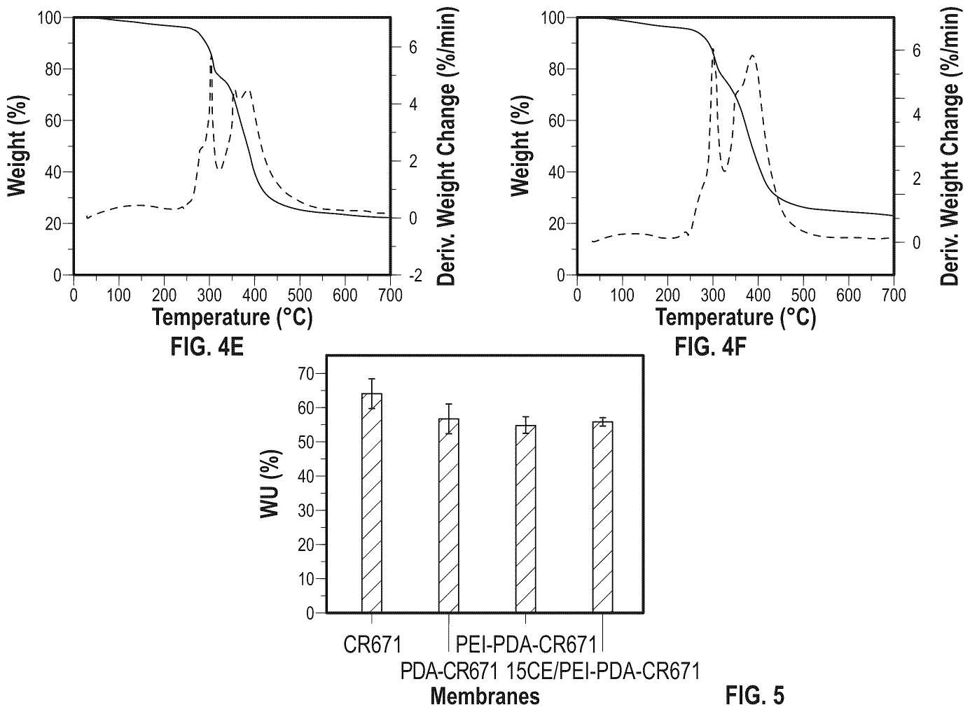

FIG. 5 shows water uptake of modified and unmodified membranes. PEI-PDA-CR671 and 15CE/PEI-PDA-CR671 membranes show reduced water uptake compared to CR671 and PDA-CR671 membranes. The water sorption characteristics exert a significant impact on the performance of CEMs in ion exchange processes. Increased water sorption raises the electrical resistance of the membrane, thereby hindering the rate of ion transport. The water uptake in CEMs is predominantly influenced by factors such as the degree of crosslinking, where higher crosslinking and lower functional group density are associated with reduced water uptake. From FIG. 5, among these membranes, CR671 exhibits the highest water uptake at 63.9%. In the membrane modified with PDA, there is a decrease in water uptake, measuring 56.7% compared to CR671. PEI-PDA-CR671 demonstrates the lowest water uptake in the range of 54.9%, attributed to the surface cross-linking effect of PEI leading to an increase in cross-linking density. In the case of 15CE/PEI-PDA-CR671, the introduction of 15CE results in a slightly higher water uptake of 55.7% compared to PEI-PDA-CR671. The diminishing water uptake of the modified membranes leads to a reduction in their electrical resistance, consequently creating the potential to enhance the transport of ions.

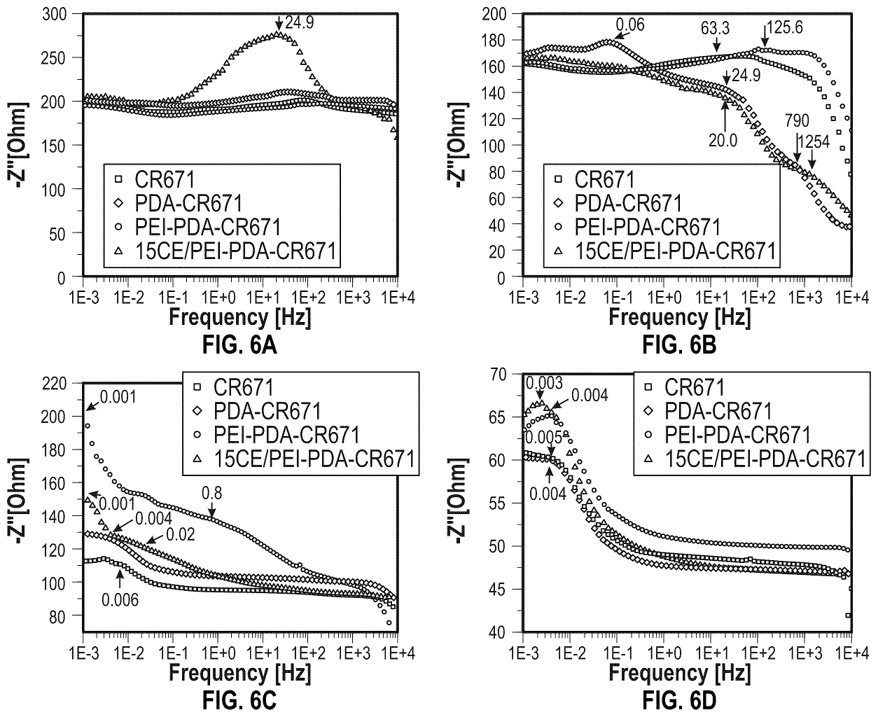

FIGS. 6A, 6B, 6C, and 6D show impedance spectra of the CR671 and modified membranes. FIG. 6A shows bond plots obtained with 0.1M LiCl. FIG. 6B shows bond plots obtained with 0.1M NaCl; FIG. 6C shows bond plots obtained with 0.1M MgCl₂. FIG. 6D shows bond plots of the membranes with the mixture solutions of MgCl₂ and LiCl (0.3 M MgCl₂ and 0.11 M LiCl). The impedance spectra for both modified and unmodified CR671 in a 0.1 M LiCl solution are depicted in FIG. 6A. In the high-frequency region, the Nyquist plots (FIG. 6E) for 15CE/PEI-PDA-CR671 and CR671 exhibit a quarter-circle, characteristic of a dielectric material, thereby forming capacitance at the interface between the coating and substrate. Furthermore, the smaller impedance arc observed in 15CE/PEI-PDA-CR671 suggests Li⁺ adsorption attributed to the 15CE modification, while CR671 displays relatively large impedance arcs. No discernible features are observed in PEI-PDA-CR671, attributable to the dense and thick surface resulting from the cross-linking of PEI. At intermediate frequencies, semi-circles manifested in the Nyquist plots of 15CE/PEI-PDA-CR671 were indicative of ion transfer through the modification layer. Additionally, an inductive arc emerged as a result of both 15CE and PEI modifications. The Bode plot (FIG. 6A) reveals two distinguishable peaks: a low-frequency peak at approximately 0.003 Hz associated with the diffusion boundary layer observed in the four membranes and a distinct peak in the case of 15CE/PEI-PDA-CR671 at 24.9 Hz, attributed to the speedy transfer of Li⁺ through ion channels originating from the 15CE modification.

The impedance spectra of both modified and unmodified CR671 in 0.1M NaCl is illustrated in FIGS. 6B and 6F. Nyquist plots for 15CE/PEI-PDA-CR671 reveal the presence of three semi-circles (FIG. 6F). The first semi-circle corresponds to the charge transfer resistance at the membrane interface, the second indicates limited species diffusion through membranes due to PEI coating, and the third signifies species adsorption/desorption at the electrode surface. Conversely, PEI-PDA-CR671 and CR671 exhibit quarter-circles, indicative of capacitance impedance. An inductive arc observed in CR671 is attributed to Na⁺ ion adsorption onto the membranes. Analysis of the Bode plot (FIG. 6B) reveals several peaks. A low-frequency peak around 0.001 Hz is attributed to the diffusion boundary layer for 15CE/PEI-PDA-CR671, PEI-PDA-CR671, and PDA-CR671. PEI-PDA-CR671 (125.6 Hz) and CR671 (63.3 Hz) exhibit prominent peaks, signifying the rapid transfer of Na⁺ facilitated by the PEI coating. For PDA-CR671 membranes, distinct peaks are observed at a low frequency of 0.06 Hz, and additional peaks are identified at high frequencies of 24.9 Hz and 790 Hz. In the case of 15CE/PEI-PDA-CR671, peaks are observed at high frequencies of 20 Hz and 1254 Hz, indicating effective Na⁺ transport through the membranes.

Impedance spectra for modified and unmodified CR671 in 0.1 M MgCl₂ is presented in FIGS. 6C and 6G. At high frequencies, Nyquist plots (FIG. 6G) for all four membranes exhibit quarter circles, acting as dielectric materials and forming capacitance at the coating-substrate interface. At low frequencies, a semi-circle appears in PEI-PDA-CR671 due to Mg²⁺ ion transfer. From the Bode plot (FIG. 6C), very low frequencies around 0.001 Hz correspond to the diffusion boundary layer for all four membranes. Peaks at 0.02 Hz for 15CE/PEI-PDA-CR671 and 0.6 Hz for PEI-PDA-CR671 indicate Mg²⁺ transfer. According to Eq (2), the time constants (T) for Li⁺, Na⁺, and Mg²⁺ are calculated as 0.008 s, 0.02 s, and 8 s, respectively, suggesting a faster transport of Li⁺ ions through 15CE/PEI-PDA-CR671 compared to Na⁺ and Mg²⁺.

FIG. 6D illustrates the Bode plot for modified CR671 and CR671 in 25 g/L (0.3 M) MgCl₂ solutions with 5 g/L (0.11 M) LiCl. In the Nyquist plots (FIG. 6H) at high and intermediate frequencies, the membranes exhibit a quarter-circle, indicative of functioning as a dielectric material and creating capacitance at the interface between the coating and the underlying substrate. Examining the Bode plot (FIG. 6D), the very low frequencies at approximately 0.003 Hz, 0.004 Hz, 0.004 Hz, and 0.005 Hz are attributed to the diffusion boundary layer for 15CE/PEI-PDA-CR671, PEI-PDA-CR671, PDA-CR671 and CR671, respectively, suggesting the lower transport rate for Mg²⁺.

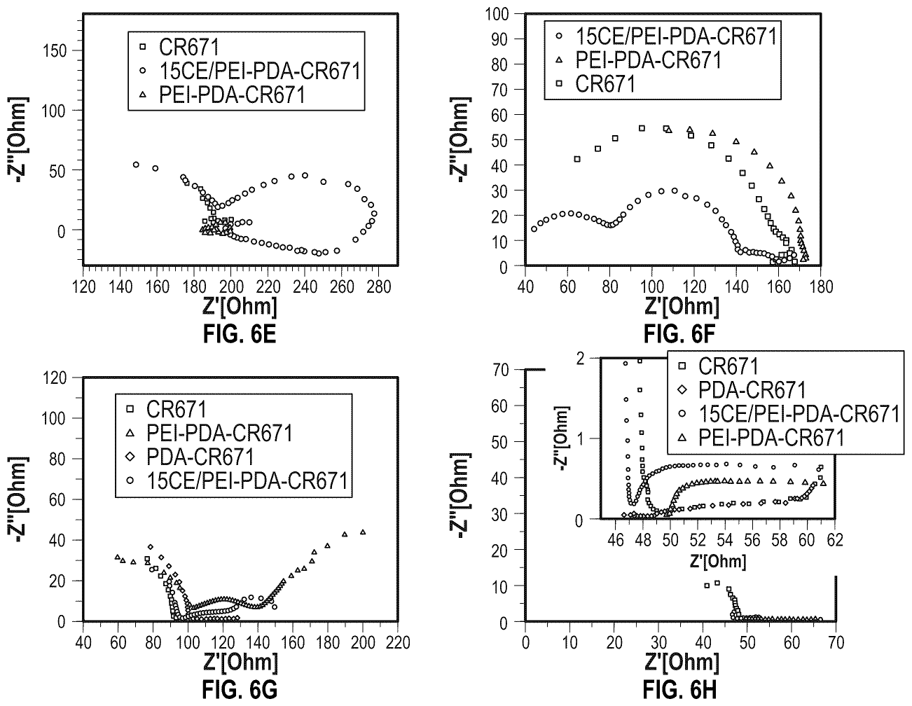

FIGS. 7A and 7B show impedance spectra of the 15CE/PEI-PDA-CR671 membranes for different concentration solutions. FIG. 7A shows bond plots in different concentrations of LiCl. FIG. 7B shows bond plots in different concentrations of MgCl₂ solutions. With the increasing salt concentration of the bulk solution, a proportional escalation in ion concentration within the modification layer ensues, leading to a diminution in the polarization resistor and the double-layer capacitor. This concomitant reduction in the time constant (T) is expected to manifest in a discernible shift of the maximum frequency (fₘₐₓ) in EIS towards higher frequencies. In the context of FIG. 7A, delineating the Bode plots for the 15CE/PEI-PDA-CR671 membranes across 0.01 M, 0.02 M, and 0.1 M LiCl solutions, a conspicuous escalation in fₘₐₓ was observed, progressing from 6.4 Hz (τ=0.03 s) to 7.8 Hz (τ=0.02 s) and ultimately reaching 24.9 Hz (τ=0.006 s). The analogous behavior is discerned in MgCl₂ solutions (FIG. 7B), where fₘₐₓ exhibits a progression from 0.001 Hz (τ=159.24 s) to 0.002 Hz (τ=79.62 s) in tandem with rising concentration.

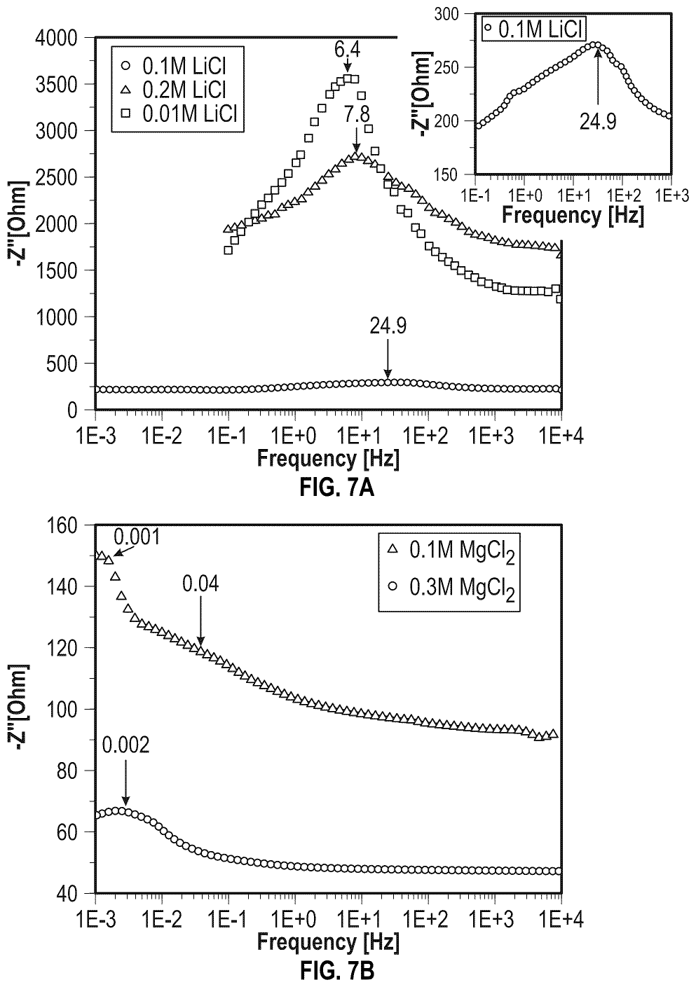

FIGS. 8A and 8B show permselectivity improvement and Li flux improvement, respectively, of the membranes in a mixture of MgCl₂ and LiCl (Mg²⁺ to Li⁺ ratio of =5:1, wt./wt.) solutions. The enhancement in membrane permselectivity and Li flux is depicted in FIG. 8, revealing improvements at a current density of 2.19 mA/cm² for 15CE/PEI-PDA-CR671. Specifically, the permselectivity is 31.8, 38.9, and 32.4 times greater than that of CR671, PDA-CR671, and PEI-PDA-CR671, respectively. Similarly, at the same current density, there is a remarkable 55-fold increase in Li flux when comparing 15CE/PEI-PDA-CR671 to CR671. Upon raising the current density to 14.97 mA/cm², the corresponding improvement factors achieve 23.2 and 16.2 when compared to PDA-CR671 and PEI-PDA-CR671, respectively. These findings collectively underscore the substantial enhancements in both permselectivity and Li flux resulting from the incorporation of 15CE into the membranes.

Despite the comparable hydrated radii of Mg²⁺ (0.428 nm) and Li⁺ (0.382 nm), the membranes 15CE/PEI-PDA-CR671 exhibit superior Li transport. Several factors contribute to this phenomenon. Firstly, ion transport through membranes may be influenced by the presence of water molecules in the holes or channels of the membranes, impeding ion transport. After modification of CR671 membranes, the water uptake of the membranes decreases compared to CR671 and PDA-CR671, resulting in fewer water molecules and reduced impedance from water molecules. Secondly, Li⁺ possesses lower hydrated energy (−590 kJ/mol) than Mg²⁺ (−2150 kJ/mol), and the cation-water distance for Mg²⁺ (1.95 Å to 2.12 Å) is greater than that for Li⁺ (1.99 Å to 2.11 Å). This suggests that Mg²⁺ has a stronger interaction with water molecules than Li⁺, indicating that Mg²⁺ would encounter a higher energy barrier to pass through the membranes compared to Li⁺. Thirdly, the PEI coating on the membrane surface causes greater electric repulsion towards divalent Mg²⁺ compared to monovalent Li⁺. Fourthly, the higher overall stabilization energy of the CE-Li complex, in comparison to the CE-Mg complex, promotes the preferential separation of Li over the competing Mg²⁺. Fifthly, the FTIR spectra reveals extensive O—H peaks in the 15CE-Mg membrane sample. The peaks (C—O) observed at 1064 cm⁻¹ undergo a shift to 1087 cm⁻¹, 1072 cm⁻¹, and 1068 cm⁻¹, which is attributed to the interaction of 15CE with Mg, Li, and Na, respectively. This shift suggests that 15CE/PEI-PDA-CR671 exhibits a strong binding capacity with Mg compared to Li and Na.

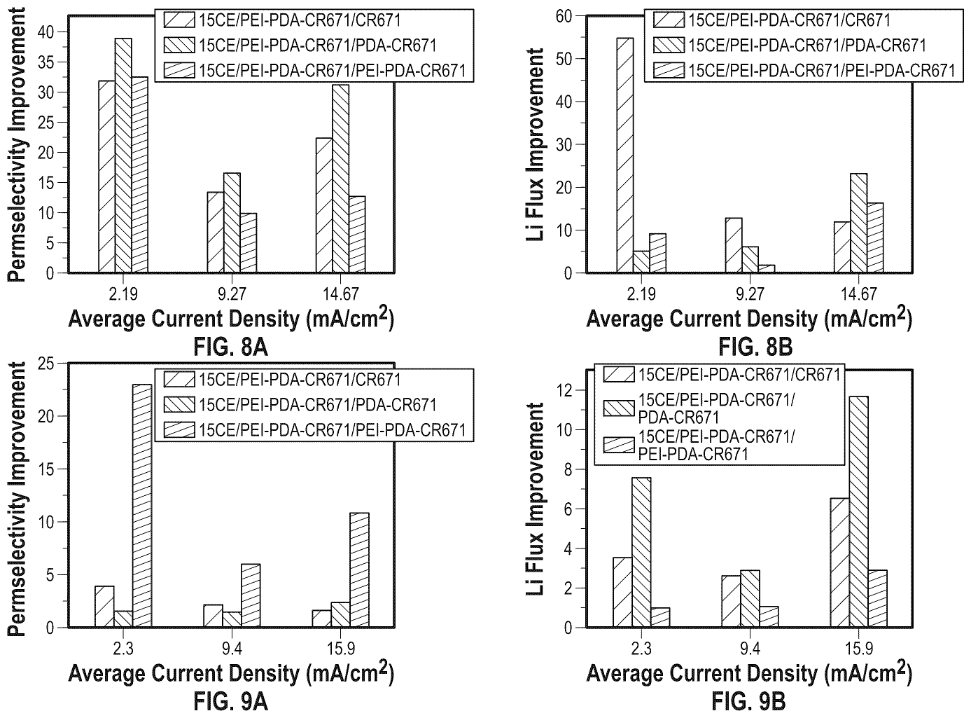

FIGS. 9A and 9B show permselectivity improvement and Li flux improvement of the membranes in a mixture of NaCl and LiCl (Na⁺ to Li⁺ ratio of =5:1, wt./wt.) solutions. The enhancement in membrane permselectivity and Li flux is depicted in FIG. 9, revealing improvements at a current density of 2.30 mA/cm² for 15CE/PEI-PDA-CR671. Specifically, the permselectivity is 3.85, 1.65, and 23.04 times greater than that of CR671, PDA-CR671, and PEI-PDA-CR671, respectively. Similarly, at the current density of 15.90 mA/cm², there is a 6.65 and 1.92-fold increase in Li flux when comparing 15CE/PEI-521 PDA-CR671 to CR671 and PEI-PDA-CR671. These findings suggest the improvement in permselectivity and Li flux resulting from 15CE/PEI-PDA-CR671 membranes.

Despite both Na⁺ and Li⁺ being monovalent ions, the modified membranes 15CE/PEI-PDA5 CR671 demonstrate superior permselectivity and higher Li flux compared to CR671, PDA-CR671, and PEI-PDA-CR671. This phenomenon may be elucidated by considering the hydrated ionic radius of Na⁺ (1.94 Å), which closely approximates the cavity size of 15CE (1.7 Å to 2.2 Å). This proximity enables Na⁺ to achieve a more favorable fit condition than Li⁺, forming the most stable complex. Additionally, due to the bulkier nature of the 15CE-Li complexes compared to Li⁺ cations, the former is less solvated by solvent molecules. Based on the ATR-FTIR result, these complexes exhibit greater mobility than the freely solvated Li⁺ cations. Consequently, Li⁺ can more easily traverse the membranes than Na⁺, contributing to the observed superior permselectivity and higher Li⁺ flux in the 15CE/PEI-PDA-CR671 membranes.

However, it is noteworthy that the permselectivity of Li⁺ in the Na/Li separation is observed to be lower than that in the separation of Mg/Li. Several factors contribute to this distinction. Firstly, the hydrated energy of Na⁺ is 420 kJ/mol, and it has a larger water-cation distance (2.36 Å to 2.53 Å) compared to Mg²⁺. As a result, Mg²⁺ exhibits a stronger interaction with water than Na⁺, making Na⁺ more permeable through the membranes than Mg²⁺. Secondly, the presence of PEI on the membrane surface results in stronger electric repulsion toward Mg²⁺ compared to Na⁺, facilitating easier access of Na⁺ to the membrane surface. These factors collectively contribute to the observed lower permselectivity of Li⁺ in the Na and Li separation compared to the Mg and Li separation, underscoring the intricate interplay of ion properties and membrane characteristics in the separation process.

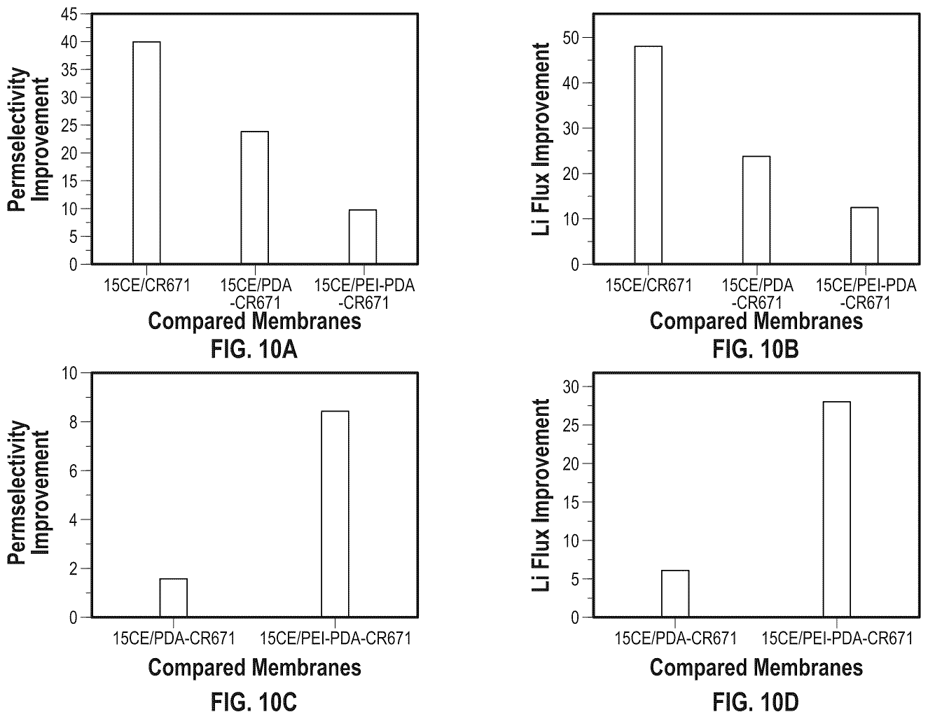

FIGS. 10A, 10B, 10C, and 10D show permselectivity and Li flux improvement measurements. FIGS. 10A and 10B show permselectivity and Li flux improvement, respectively, of the membranes in a Mg²⁺/Li⁺ solution (Mg²⁺ to Li⁺ ratio=5:1, wt./wt.). FIGS. 10C and 10D show permselectivity and Li flux improvement, respectively, of the membranes in a Na/Li solution (Na⁺ to Li⁺ ratio=5 to 1, wt./wt.). Current density is 14.97 mA/cm² for Mg²⁺/Li⁺ and 15.90 mA/cm² for Na⁺/Li⁺. Operating time is 4 hours. 15CE refers to 15CE/PEI-PDA-CR671.

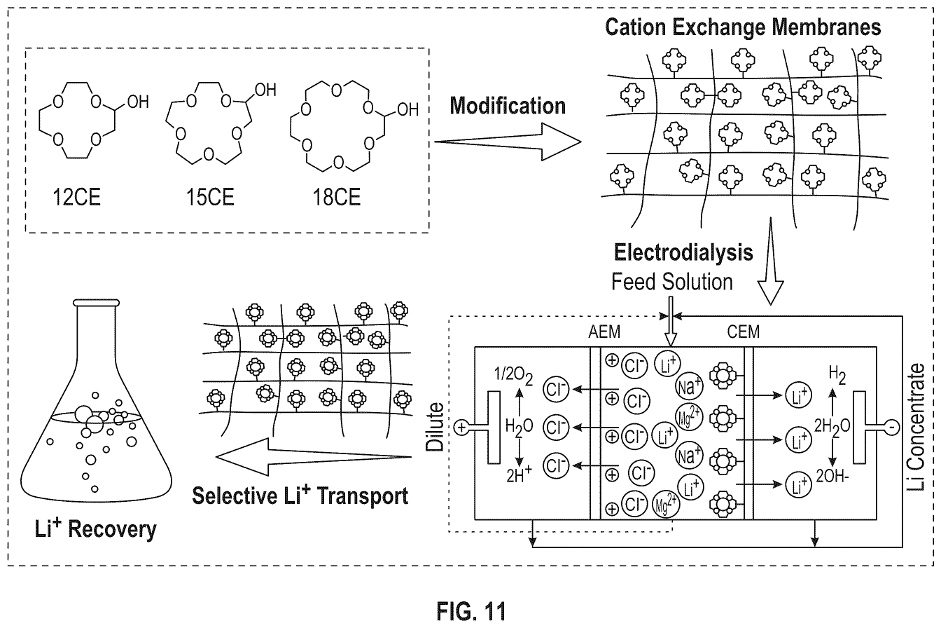

FIG. 11 shows a process flow for lithium recovery using a crown ether.

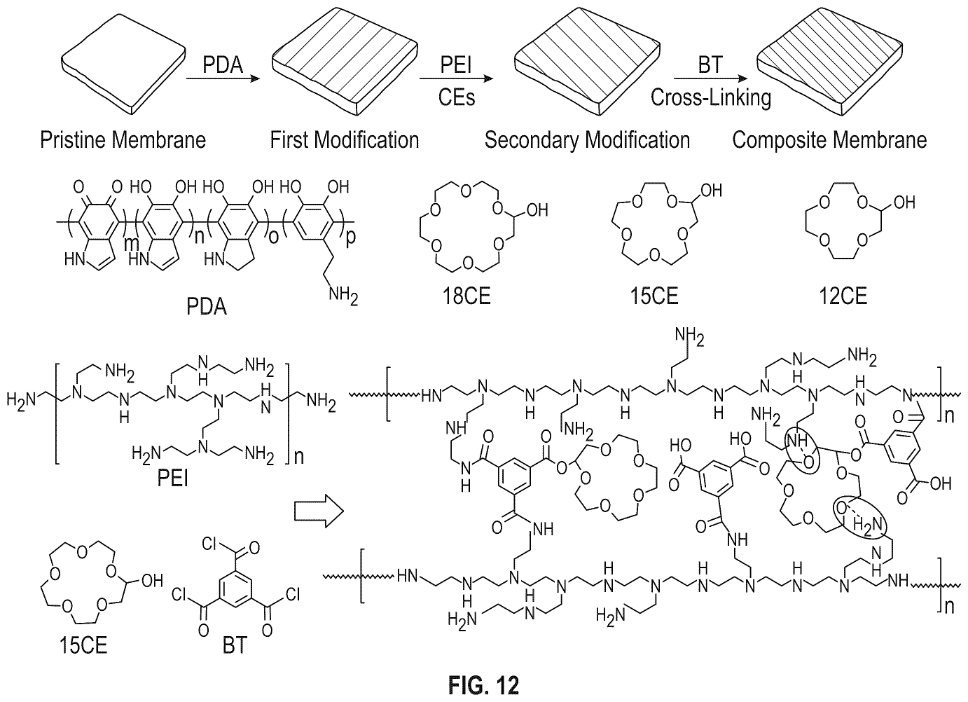

FIG. 12 shows process of modification of modified membranes.

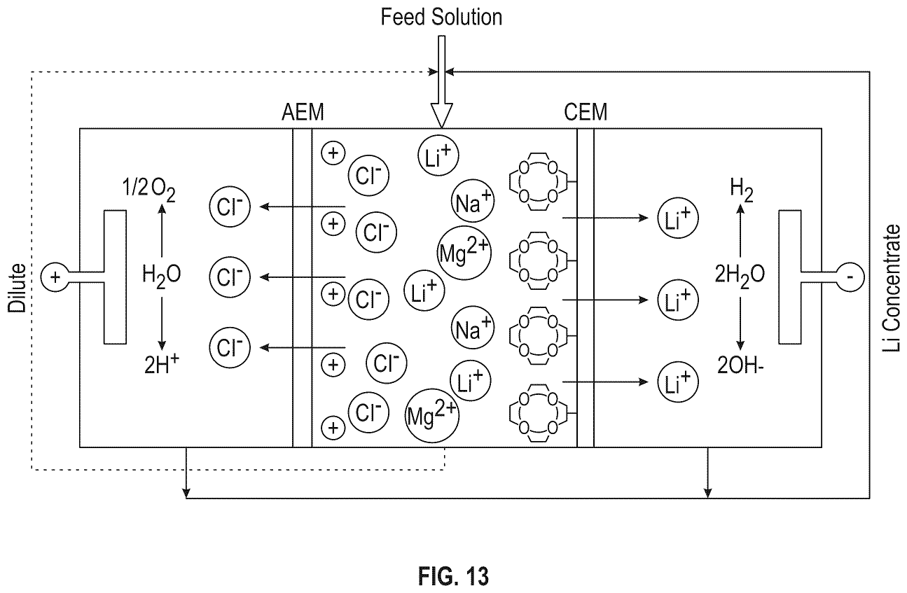

FIG. 13 shows Li⁺ separation mechanism of selective membranes via electrodialysis.

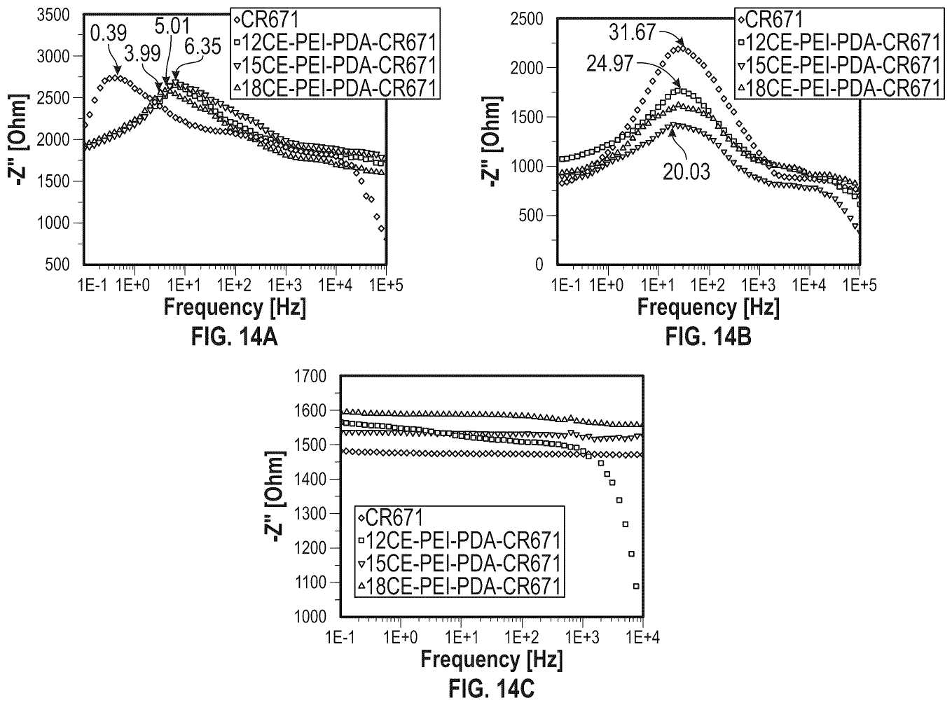

FIGS. 14A, 14B, 14C, 14D, 14E, and 14F show the bond plots for modified and unmodified membranes in low concentration solutions. FIGS. 14A, 14B, and 14C show the bond plots in the lower concentration solutions of 0.01M of LiCl, MgCl₂, and NaCl, respectively. FIGS. 14D, 14E, and 14F show the bond plots in the lower concentration solutions of 0.02 M LiCl, MgCl₂, and NaCl, respectively. The EIS outcomes for the modified membranes in low-concentration solutions is depicted in FIGS. 14A, 14B, 14C, 14D, 14E, and 14F. In 0.01 M solutions of LiCl, MgCl₂, and NaCl, the EIS of the membranes is presented in FIGS. 14A, 14B, and 14C. FIG. 14A shows that, in contrast to the pristine membranes CR671, which has peaks at a low frequency (0.39 Hz), the modified membranes exhibit conspicuous peaks indicative of Li⁺ transport at higher frequencies. Specifically, 12CE/PEI-PDA-CR671 operates at 5.01 Hz, 18CE/PEI-PDA-CR671 at 3.99 Hz, and 15CE/PEI-PDA-CR671 displays peaks at 6.35 Hz. Concerning the membranes in the 0.01 M MgCl₂ solution, all membranes display significant peaks at higher frequencies. CR671 exhibits peaks at 31.67 Hz, while 12CE/PEI-PDA-CR671, 18CE/PEI-PDA-CR671, and 15CE/PEI-PDA-CR671 are recorded at 24.97 Hz, 24.97 Hz, and 20.03 Hz, respectively, (FIG. 14B). In the case of 0.01 M NaCl, the membranes demonstrate diminished peaks indicative of Na⁺ transport (FIG. 14C). The time constant (T) at the maximum frequency (fₘₐₓ) for ion transport may be calculated using Eq. (2). In 0.01 M alkali solutions, the modified membranes 12CE/PEI-PDA-CR671, 15CE/PEI-PDA-CR671, and 18CE/PEI-PDA-CR671 exhibit lower transport speed for Li⁺ compared to Mg²⁺, and the constant time T is 0.032 s, 0.039 s, and 0.025 s for Li⁺ transport, respectively.

In 0.02 M solutions of LiCl, MgCl₂, and NaCl, the EIS results are depicted in FIGS. 14D, 14E, and 14F. In contrast to the pristine membranes CR671 in the 0.02 M LiCl solution, which manifest slight peaks at a low frequency, the modified membranes exhibit conspicuous peaks indicative of Li⁺ transport at higher frequencies. Specifically, 12CE/PEI-PDA-CR671 shows a peak at 5.01 Hz, 18CE/PEI-PDA-CR671 at 3.99 Hz, and 15CE/PEI-PDA-CR671 at 6.35 Hz (FIG. 14D). In the 0.02 M MgCl₂ solution, the membranes exhibit increased resistances at elevated frequencies compared to those observed in 0.01 M MgCl₂ solutions, displaying subtle peaks at higher frequencies (FIG. 14E). This behavior is attributed to the increasing electrostatic repulsion between PEI on the membrane surface and multivalent Mg²⁺ ions with rising Mg²⁺ concentration. Within the NaCl solution (FIG. 14F), the modified membranes (12CE/PEI-PDA-CR671, 15CE/PEI-PDA-CR671, and 18CE/PEI-PDA-CR671) show no discernible ion transport peaks, indicating a lack of high-speed transport for Na⁺. In contrast to Na⁺ and Mg²⁺, the monovalent ions Li⁺ in the 0.02 M LiCl solution exhibit accelerated transport with increasing concentration, surpassing the transport observed in 0.01 M NaCl solutions. This phenomenon is attributed to the concentration-dependent augmentation of Li⁺ transport. The modified membranes manifest notable peaks at high frequencies; 12CE/PEI-PDA-CR671, 15CE/PEI-PDA-CR671, and 18CE/PEI-PDA-CR671 were recorded at 6.35 Hz (τ=0.025 s), 7.88 Hz (τ=0.020 s), and 5.01 Hz (τ=0.032 s), respectively. Compared to the 0.01 M LiCl solution, the modified membranes exhibit accelerated Li⁺ transport in 0.02 M LiCl.

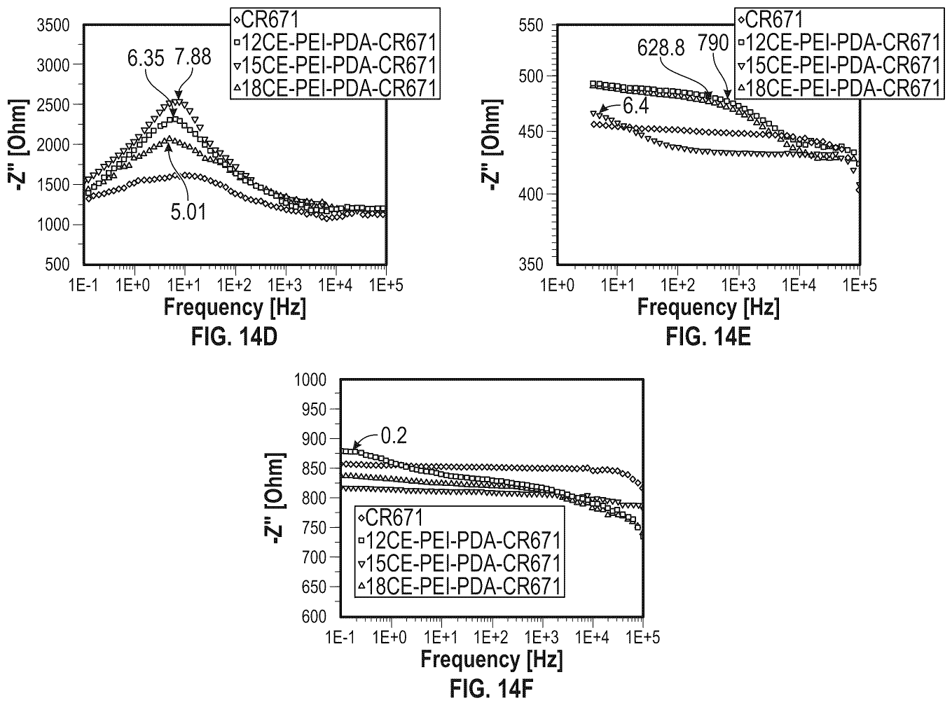

FIGS. 15A, 15B, 15C show the bond plots for modified and unmodified membranes in high concentration solutions of 0.1M LiCl, MgCl₂, and NaCl, respectively. FIG. 15D shows the Nyquist plot for modified and unmodified membranes in 0.1M NaCl. In 0.1 M solutions of LiCl, MgCl₂, and NaCl, the Bond plots of the membranes are presented in FIGS. 15A, 15B, and 15C. In the 0.1 M LiCl solution, at high frequencies, 12CE/PEI-PDA-CR671, 15CE/PEI-PDA-CR671, and 18CE/PEI-PDA-CR671 exhibit prominent peaks at 20 Hz (τ=0.008 s), 24.9 Hz (τ=0.006 s), and 15.8 Hz (τ=0.010 s), respectively (FIG. 15A). In 0.1 M MgCl₂ solution, slight peaks for Mg²⁺ ion transport are observed at low frequency, attributed to the diffusion boundary layer for the four membranes (FIG. 15B). In 0.1 M NaCl solution, the CR671 membranes record a peak at 64.3 Hz, while the modified membranes exhibit peaks at 31.7 Hz (18CE/PEI-PDA-CR671), 24.9 Hz (12CE/PEI-PDA-CR671), and 12.5 Hz (15CE/PEI-PDA-CR671). This indicates that the modified membranes attenuate Na⁺ transport through the membranes (FIG. 15C). A comparative examination reveals that Li⁺ exhibits faster transport rates in higher-concentration solutions than multivalent ions (e.g., Mg²⁺), signifying the effective transport of Li⁺. Meanwhile, the modified membranes consistently demonstrate stable and accelerated transport for Li⁺ regardless of concentration, showcasing their good performance for Li⁺ selectivity. In FIG. 15D, the Nyquist plots in a 0.1 M NaCl solution at high and intermediate frequencies reveal that 12CE/PEI-PDA-CR671, 15CE/PEI-PDA-CR671, and 18CE/PEI-PDA-CR671 exhibit distinctive patterns characterized by three quarter-circles. The initial semi-circle corresponds to the charge transfer resistance at the interface of the membrane, the second signifies constrained species diffusion through the membranes attributed to the presence of PEI and CE coating, and the third indicates processes related to species adsorption/desorption at the electrode surface. In contrast, for CR671, a substantial semi-circle is observed, attributed to the adsorption of Na⁺ ions onto the membranes.

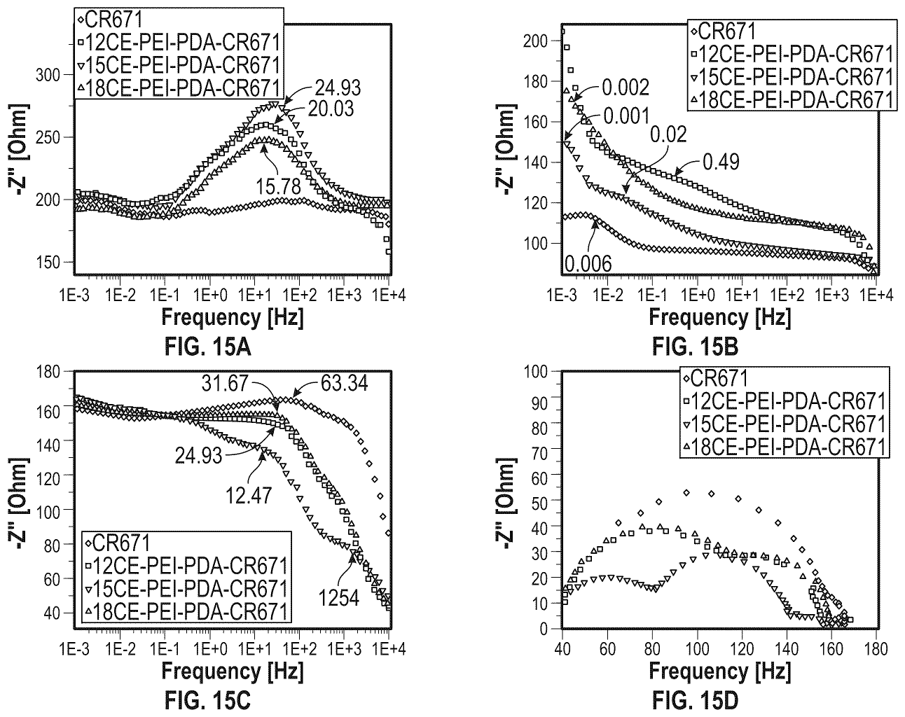

FIGS. 16A and 16B show the characterization of modified membranes with CEs using ATR-FTIR and zeta potential, respectively. FIGS. 16C and 16D show the TGA of 12CE/PEI-PDA-CR671 and the TGA of 18CE/PEI-PDA-CR671, respectively.

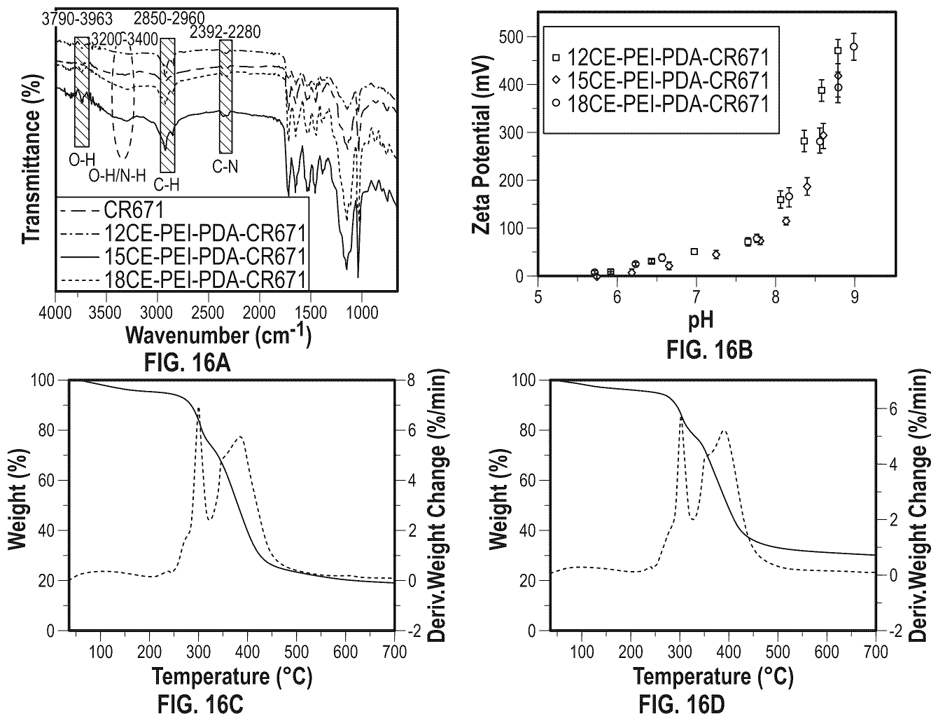

FIG. 17 shows water uptake of modified membranes in deionized water, Mg²⁺/Li⁺ (2.2 mole/mole), and Na⁺/Li⁺ (3.6 mole/mole) solution. The error bars represent triplicate measurements. The permselectivity of membranes is intricately associated with both their water uptake and the characteristics of the surrounding medium. FIG. 17 illustrates the examination of diverse mediums on membrane water uptake. In deionized (“DI”) water, the modified membranes exhibit reduced water uptake compared to the unmodified CR671 membrane. This decline is attributed to the cross-linking of PEI, leading to an increased crosslinking density in the modified membranes.

Among the modified membranes, the 15CE/PEI-PDA-CR671 (56.7%) membranes demonstrate the lowest water uptake in DI water, followed by the 12CE/PEI-PDA-CR671 (57.2%) and the 18CE/PEI-PDA-CR671 (57.6%). Contrastingly, in alkali solutions, the water uptake of the modified membranes surpasses that in DI water, attributable to the binding of hydrated alkali ions (e.g., Li⁺, Na⁺, Mg²⁺). The 18CE/PEI-PDA-CR671 membranes exhibit the highest water uptake, followed by the 15CE/PEI-PDA-CR671 and 12CE/PEI-PDA-CR671 membranes in the Mg²⁺/Li⁺ and Na⁺/Li⁺ mixture solution. Consequently, the 18CE/PEI-PDA-CR671 membrane demonstrates the highest water uptake among the modified membranes due to the formation of this stable complex. In the Na⁺/Li⁺ mixture solution, the water uptake surpasses that observed in the Mg²⁺/Li⁺ mixture solution. This observation suggests that a higher proportion of hydrated Na⁺ is bonded with the CEs in modified membranes compared to hydrated Mg²⁺, owing to the smaller hydrated ion radius of Na⁺ in contrast to Mg²⁺. Moreover, the protonation of water within the aqueous environment, resulting in the generation of hydronium ions (H₃O⁺). These H₃O⁺ form proton bridges with the six oxygen atoms present in the 18CE cavity, establishing a stable complex between 18CE and H₃O⁺, resulting in higher water uptake of 18CE/PEI-PDA-CR671 (72.2%) membranes compared to 15CE/PEI-PDA-CR671 (71.8%) and 12CE/PEI-PDA-CR671 (71.6%) in the Na⁺/Li⁺ and Mg²⁺/Li⁺ mixture solution. This phenomenon implies that the modified membranes containing CEs can accommodate hydrated alkali ions compared to CR671.

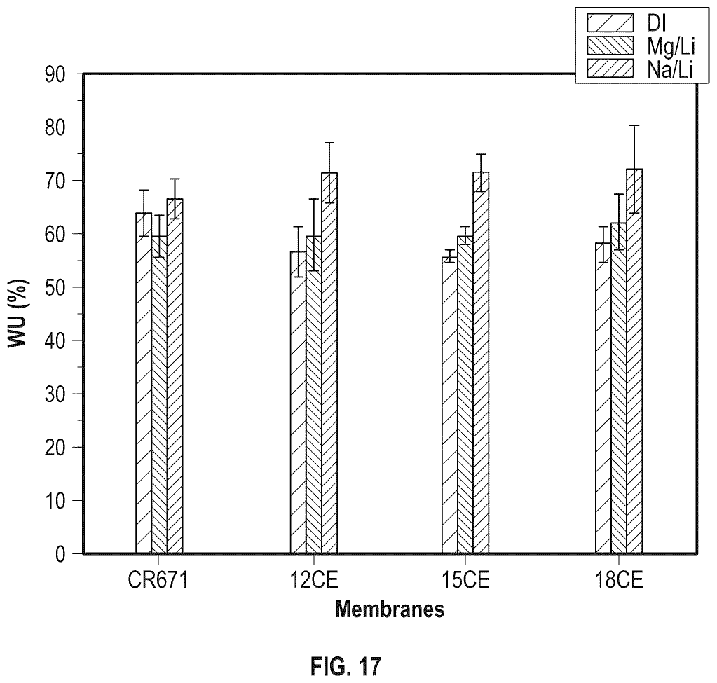

FIGS. 18A and 18B show the comparison of permselectivity and Li⁺ flux improvement, respectively of the three modified membranes in Na⁺/Li⁺ solution (3.6 mole/mole). 15CE refers to 18CE/PEI-PDA-CR671; 18CE refers to 18CE/PEI-PDA-CR671, and 12CE refers to 12CE/PEI-PDA-CR671. FIGS. 18A and 18B illustrate the permselectivity and Li⁺ flux improvement of the modified membranes in a Na⁺/Li⁺ solution. Membranes 12CE/PEI-PDA-CR671 and 18CE/PEI-PDA-CR671 demonstrate permselectivity improvements, approximately 11.9-fold and 10.4-fold, respectively, when compared to PEI-PDA-CR671 at a current density of 15.9 mA/cm². In comparison, 15CE/PEI-PDA-CR671 exhibit higher permselectivity improvement, approximately 3.3-fold and 1.7-fold, compared to 12CE/PEI-PDA-CR671 and 18CE/PEI-PDA-CR671 at a current density of 2.3 mA/cm² (FIG. 18A).

Following an additional 4 hours, Li⁺ flux improvements are observed, reaching approximately 8.7-fold and 8.1-fold when comparing 12CE/PEI-PDA-CR671 and 18CE/PEI-PDA-CR671 to PEI-PDA-CR671. 15CE/PEI-PDA-CR671 exhibits higher Li⁺ flux improvement, approximately 3.2-fold and 3.4-fold, at a current density of 15.9 mA/cm² when comparing 12CE/PEI-PDA-CR671 and 18CE/PEI-PDA-CR671 (FIG. 18B).

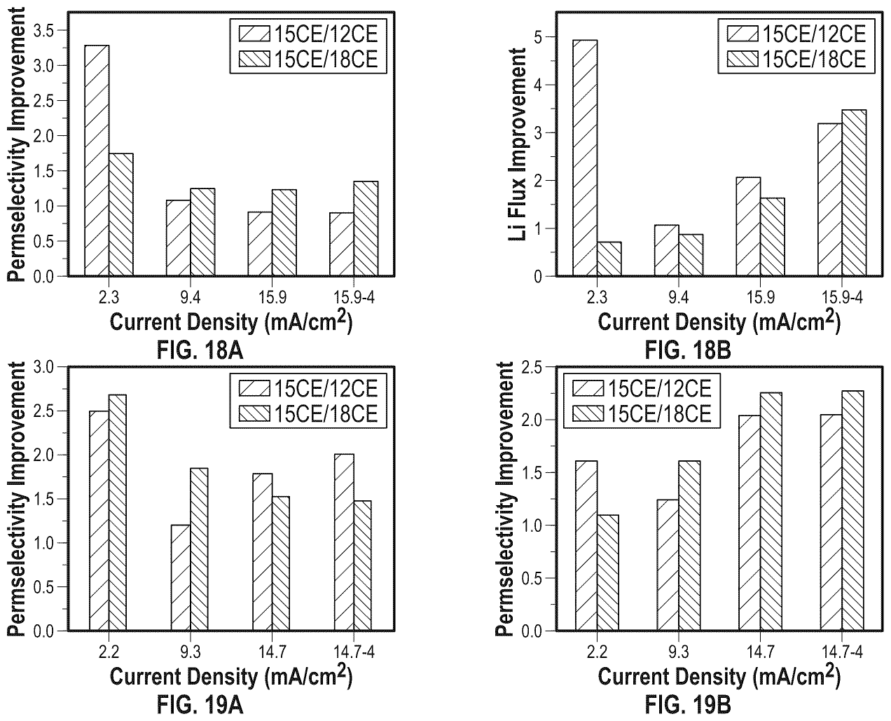

FIGS. 19A and 19B show the permselectivity and Li⁺ flux improvement, respectively, of the membranes in Mg²⁺/Li⁺ brines with a mole ratio of 2.2. FIGS. 19A and 19B illustrate the permselectivity and Li⁺ flux enhancements achieved by the modified membranes in a Mg²⁺/Li⁺ solution. The membranes 12CE/PEI-PDA-CR671 and 18CE/PEI-PDA-CR671 demonstrate permselectivity improvements, approximately 17.2-fold and 20.4-fold, respectively, when compared to PEI-PDA-CR671 at a current density of 14.6 mA/cm². In comparison, 15CE/PEI-PDA-CR671 exhibit a greater permselectivity improvement, approximately 2.4-fold and 2.6-fold, in comparison to 12CE/PEI-PDA-CR671 and 18CE/PEI-PDA-CR671 at a current density of 2.2 mA/cm² (FIG. 19A).

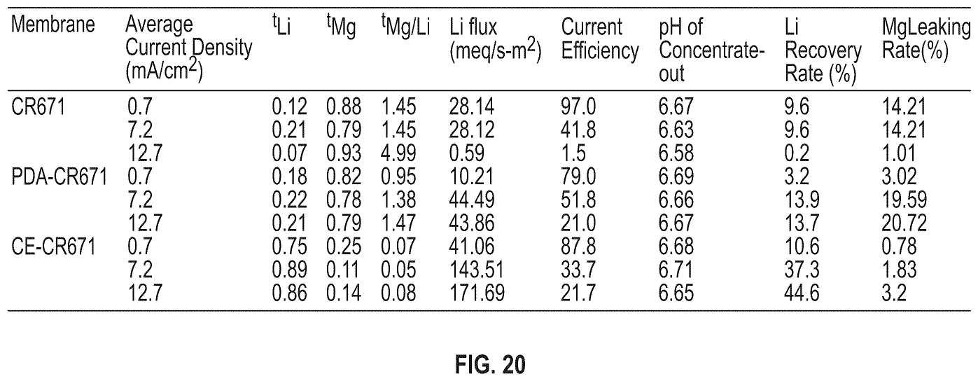

FIG. 20 shows a table of lithium recovery performance and permselectivity for Li⁺ and Mg²⁺ of the modified and unmodified CR671 lab scale aqueous solution electrodialysis.

Following an additional 4 hours, significant enhancements in Li⁺ flux are observed, reaching approximately 34-fold and 49.8-fold when comparing 12CE/PEI-PDA-CR671 and 18CE/PEI-PDA-CR671 to CR671 at a current density of 14.7 mA/cm². The membrane 15CE/PEI-PDA-CR671 demonstrates superior permselectivity enhancements, approximately 2.4-fold and 2.7-fold, at a current density of 2.2 mA/cm², and Li⁺ flux improvements were approximately 2.1-fold and 2.3-fold when compared to 12CE/PEI-PDA-CR671 and 18CE/PEI-PDA-CR671 and 14.7 mA/cm², respectively (FIG. 19B).

The modified membranes demonstrate higher Li⁺ recovery efficiencies in Na⁺/Li⁺ brines than Mg²⁺/Li⁺ brines while simultaneously displaying lower permselectivity in Na⁺/Li⁺ brines as opposed to Mg²⁺/Li⁺ brines. Several factors contribute to the preference for sodium ion transport over magnesium ion through the modified membranes. Firstly, the self-diffusion coefficient of Na⁺ is greater than that of Mg²⁺, implying that Na⁺ has a higher potential to reach or contact the membranes. Secondly, the number of water molecules bound to Na⁺ and Mg²⁺ is 5.6 and 6.0, respectively, impeding a slower movement of Mg²⁺ from the liquid solution toward the membranes compared to Na⁺. These factors collectively reduce the permselectivity of the membranes for Li⁺ in Na⁺/Li⁺ brines.

An interfacial polymerization technique may be used to modify a cation exchange membrane including, but not limited to, CR671, to enhance metal transport selectivity and capacities. The membrane comprises a two-layer coating. A first layer may comprise polydopamine (“PDA”), polyvinyl alcohol (“PVA”) and PVA-SbQ, and the second layer may comprise polyethyleneimine (“PEI”) and polyvinyl alcohol (“PVA”), The first layer facilitates subsequent coating with PEI or PVA. The second layer may comprise 15-crown-5 ether (“15CE”) and may create a channel for metal transport through crosslinking with 1,3,5-benzenetricarbonyl trichloride.

The 15CE-PEI-PDA-CR671 membrane may be coated with 15CE and may comprise a positive surface charge. PEI may create a positive surface charge. The membrane may comprise a reduced impedance for metal transport, compared to the traditional membrane, indicating the membrane's high transport potential and selectivity for a metal. The membrane may achieve up to 80% and 90% metal recovery from Mg²⁺/Li⁺ and Na⁺/Li⁺ solutions, respectively. The membrane may show enhanced selectivity, as evidenced by lower relative transfer numbers (t_{Mg/Li} and t_{Na/Li}) compared to other membranes.

Using crown ethers (“CE”) as ligands for alkali ions (“CE”) may enhance the selectivity of cation exchange membranes (“CEM”). CEs (12-crown-4 ether (12CE), 15-crown-5 ether, and 18-crown-6 ether) have an affinity to Li⁺ during adsorption and separation. The membrane may comprise a CE to enhance the Li⁺ recovery efficiency of a mono-selective cation exchange membrane, CR671, via electrodialysis.

The membrane may be formed by initial treatment with polydopamine (“PDA”) followed by the deposition of complexes of polyethyleneimine (“PEI”) and different CEs (12CE, 15CE, and 18CE) bonded through hydrogen bonds. Specific channels for metal ion transport through membranes 12CE/PEI-PDA-CR671, 15CE/PEI-PDA-CR671, and 18CE/PEI-PDA-CR671 may be formed by interfacial polymerization with 1,3,5-benzenetricarbonyl trichloride crosslinks in PEI. 12CE/PEI-PDA-CR671, 18CE/PEI-PDA-CR671, and 15CE/PEI-PDA-CR671 may have greater permselectivity and Li⁺ flux improvements relative to traditional membrane. In Na⁺/Li⁺ and Mg²⁺/Li⁺ brines, 15CE/PEI-PDA-CR671 may have superior improvements in permselectivity (approximately 3.3-fold and 1.7-fold) and (2.4-fold and 2.6-fold) compared to 12CE/PEI-PDA-CR671 and 18CE/PEI-PDA-CR671 at current densities of 2.3 mA/cm² and 2.2 mA/cm², respectively. Additionally, at 15.9 mA/cm² in Na⁺/Li⁺ brines and 14.7 mA/cm² in Mg²⁺/Li⁺ brines, 15CE/PEI-PDA-CR671 may have higher Li⁺ flux improvements, approximately 3.2-fold and 3.4-fold, and 2.1-fold and 2.3-fold, respectively, compared to 12CE/PEI-PDA-CR671 and 18CE/PEI-PDA-CR671.

The membrane may comprise 15-crown-5-ether (“15CE”) to enhance Li⁺ selectivity in Mg²⁺/Na⁺ brine solutions. The membrane may comprise polydopamine (“PDA”) as a non-selective deposition agent on CEM surfaces with low surface energy. PDA may enhance substrate surface hydrophilicity, ensuring uniformity that proves advantageous for subsequent polymeric processes, and endows anti-fouling and anti-scaling properties during the treatment of brine. Additionally, polyethyleneimine (“PEI”), distinguished by its hyperbranched structure and plentiful positively charged amine groups, may establish hydrogen bonds that facilitate the immobilization of CEs onto the membrane surface. The introduction of PEI may induce substantial electric repulsion at the membrane surface, resulting in heightened perm-selectivity, particularly towards multivalent cations (e.g., Ca²⁺ and Mg²⁺). Simultaneously, the crosslinking of PEI by 1,3,5-benzenetricarbonyl trichloride (“BT”) establishes 15CE as conduits for Li⁺ ions.

The membrane may be a cation-exchange membrane (“CEM”) comprising CEs. 12CE, 15CE, and 18CE may modify the CEM CR671 to selectively recover Li⁺ from Na⁺/Li⁺ and Mg²⁺/Li⁺ brines. Selective membranes for metal recovery may be prepared using CR671 as a pristine membrane. Polydopamine (“PDA”) may be used to facilitate the deposition of the complex of polyethyleneimine (“PEI”) and various CEs (12CE, 15CE, and 18CE) bonded through hydrogen bonds. To reinforce the structure, the cross-linker 1,3,5-benzenetricarbonyl trichloride (“BT”) may be utilized to cross-link PEI, thereby enabling the specific cavities of the CE to selectively transport targeted alkali metal ions (e.g., Li⁺) in a high ratio of Mg²⁺/Li⁺ or Na⁺/Li⁺ brines.

The cation exchange membrane CR671, may comprise a cross-linked copolymer comprising sulfonic acid functional groups. The sulfonic acid functional groups may be derived from vinyl compounds. The CR671 membrane may comprise a thickness of at least about 520 μm, about 520 μm to about 540 μm, about 525 μm to about 535 μm, or about 540 μm. The CR6371 membrane may be used in electrodialysis for cations separation from a solution and may comprise a thin PEI coating. The chemical modifiers, dopamine hydrochloride (“DA”), 1,3,5-benzenetricarbonyl trichloride (“BT”), sodium dodecyl sulfate (“SDS”), trimethylol aminomethane (“Tris”), Na₂CO₃, KCl, and NaCl, may be contacted with the CR671 membrane to modify the CR671 membrane. Various CEs, including 2-(hydroxymethyl)-12-crown 2-ether, 2-(hydroxymethyl)-18-crown 8-ether, 2-(hydroxymethyl)-15-crown 5-ether, along with MgCl₂ and LiCl, may be attached to a coating of the CR671 membrane.

### INDUSTRIAL APPLICABILITY

The invention is further illustrated by the following non-limiting examples.

### Example 1

A CR671 cation exchange membrane was modified. The unmodified CR671 membrane was made up of a cross-linked copolymer of vinyl compounds featuring sulfonic acid functional groups. 2-(hydroxymethyl)-15-crown-5 ether, LiCl, and MgCl₂ were provided. Dopamine hydrochloride (“DA”), 1,3,5-benzenetricarbonyl trichloride (“BT”), Na₂CO₃, sodium dodecyl sulfate (“SDS”), NaCl, KCl, and trimethylol aminomethane (“Tris”) were sourced, while other analytical agents were used as received without additional treatment. PEI, an analytical-grade substance with a 50 wt. % concentration in an aqueous solution, was obtained.

### Example 2

CR671 membranes were employed in the process of membrane modification. 2 g of dopamine hydrochloride underwent dissolution in 1000 mL of trimethylol aminomethane-hydrochloride (“Tris-HCl”) buffer solution within a pH range of 8.5 to 8.8, for the preparation of PDA. The manifestation of PDA formation was evidenced by a discernible change in the color of the solution to brown. The CR671 membrane was vertically immersed in a beaker containing the freshly prepared PDA solution at room temperature for 4 hours, resulting in the designation PDA-CR671. Following this, 0.05 g of SDS, 0.05 g of Na₂CO₃, PEI, and 15CE were separately dissolved in 50 mL of DI water with stirring for 30 min and cast onto the surface of the PDA-CR671 membranes for 10 min. BT was used to cross-link PEI by water-bathing at 40° C. for 15 min, leading to the formation of 15CE/PEI-PDA-CR671, which was subsequently stored in deionized (“DI”) water for use. Control samples were prepared using the same procedure, omitting the inclusion of crown ethers, and were denoted as PEI-PDA-CR671.

### Example 3

The chemical compositions of the membranes were analyzed through attenuated total reflectance Fourier transform infrared spectroscopy (“ATR-FTIR”). The membranes, cut into 4 cm² pieces, were subjected to 24 hours of drying in a vacuum oven. Subsequently, ATR-FTIR scans were conducted on the dried membrane specimens. The surface charge of the membranes was analyzed in relation to the pH of the solution to determine their zeta potential. Prior to measurement, the membranes were soaked in DI water for 24 hours to remove any residue chemicals. The pH was adjusted using 0.1 M HCl and NaOH solutions, and the measurements were taken using a 0.01 M KCl electrolyte. The target pressure for the measurement was 400 mbar. To assess the thermal stability of the membrane samples, a thermogravimetric analysis (“TGA”) was conducted.

### Example 4

The water uptake of membranes was defined as the quantity of water that a membrane can absorb under specific conditions. This property was measured experimentally by measuring the weight of membranes before and after exposure to water. The membrane sections were submerged in deionized water at room temperature for 24 hours. Subsequently, the membrane pieces are promptly weighed after removal from the water. Following this, the membrane pieces underwent drying in a vacuum oven at 40° C. for 24 hours, and their weight was measured. Water uptake is calculated by the measured difference in weight before and after water exposure, normalized by the initial weight. The percentage water uptake (“WU”) is determined using Eq (1):

$$W U ( \% ) = ( {W}_{s} - {W}_{d} ) / {W}_{d} \times 100 \qquad ( 1 )$$

where, WU (%) is the percentage of water uptake, Wₛ (g) is the weight of membranes after exposure to water 24 hours, W_{d} (g) is the weight of the dried membrane.

### Example 5

Electrical impedance spectroscopy (“EIS”) was employed to assess the electrical resistance of modified and unmodified CEMs. A four-electrode method, the membrane sample, with an effective area of 0.8 cm², was positioned between two compartments filled with equal volumes of 0.1 M MgCl₂, 0.1 M NaCl, and 0.1 M LiCl electrolyte solutions. An alternating current (“AC”) ranging from 10000 Hz to 0.001 Hz was applied at room temperature (25±1° C.). Prior to the EIS experiment, membrane samples were equilibrated in the working electrolyte solution for 24 hours. Ion transport time through the interface between the surface coating and the membrane was identified by analyzing impedance spectra at the frequency impedance peak (fₘₐₓ) using Eq (2).

$$τ = 1 / ( 2 π {f}_{max} ) \qquad ( 2 )$$

### Example 6

A bench-scale electrodialysis system was constructed, and experiments were systematically conducted under controlled conditions. For the feed solutions, 4 L volumes were prepared, containing 5 g/L of LiCl and 25 g/L of MgCl₂, or 5 g/L of LiCl and 25 g/L of NaCl, respectively. The electrode rinse solution consisted of a 5 L solution of 2 wt. % Na₂SO₄. The electrodialysis stack comprised ten pairs of ion-exchange membranes (“IEMs”), including eleven CEMs either modified or unmodified, and the same ten anion exchange membranes (“AEMs”). The experiments were conducted in continuous flow mode, with feed/dilute and concentrate recirculated to a 4 L feedwater tank. Flow rates for both the feed and concentrate streams were maintained at 180 mL/min, and the system's flow rate was calibrated to achieve a linear flow velocity of 33.5 cm/s in each stream. Detailed electrodialysis operating conditions and specifications are outlined in Table 1, shown below. Throughout the bench-scale testing, the applied current density remained below the initially measured limiting current density, which was determined at the commencement of the experiments upon membrane installation. The concentrations of Li⁺, Mg²⁺, and Na⁺ were analyzed at an interval of 1 hour at different current densities. The efficiency of lithium recovery was defined according to Eq (3):

$$Li recovery ( \% ) = ( {C}_{out} - {C}_{in} ) / {C}_{in} \times 100 \qquad ( 3 )$$

where, Cₒᵤₜ and Cᵢₙ are the lithium concentration of concentrate-out and concentrate-feeding (mg/L), respectively, of the electrodialysis system.

TABLE 1
Electrodialysis stack specifications and operational parameters

| Component | Type | Characteristics |
|---|---|---|
| EDR stack | single stage | electrode: Pt/Ir-MMO-coated Ti |
| | | processing length: 2.8 cm |
| IEMs | CEMs | CR671 |
| | | PDA-CR671 |
| | | PEI-PDA-CR671 |
| | | 15CE/PEI-PDA-CR671 |
| | AEMs | AR204 |
| effective | | 8 cm² |
| membranes area | | |
| spacer thickness | gasket | 0.32 mm |
| volumetric flow | dilute and | 180 mL/min (33.5 cm/s) |
| rate | concentrate | |
| (linear velocity) | electrode rinse | 180 mL/min (33.5 cm/s) |

The current efficiency of electrodialysis was determined as:

$$Current efficiency ( \% ) = [ \sum Fqz ( {C}_{in} - {C}_{out} ) ] / NI \times 100 \qquad ( 4 )$$

where, F denotes the Faraday constant (96,485 C/mol), z represents the charge of the ion, q indicates the flow rate of concentrate-out (L/s), Cᵢₙ and Cₒᵤₜ refer to the concentrations of concentrate-feeding and concentrate-out of the ions (mol/L), and N and I signify the number of membrane cell pairs and the applied current (“Amp”). The Li flux (molar equivalents (“mEq”)/s·m²) was computed as:

$$Li flux = ( Equivalent of Li recovered \times flow rate ) / Effective membrane surface area \qquad ( 5 )$$

The transfer of the specific cations i (e.g., I=Na⁺, Mg²⁺, or Li⁺) was determined by the cation transport number calculated as:

$$ti = Equivalent of i transported / Equivalent of total cations transported \qquad ( 6 )$$

The permselectivity of membranes for Li⁺, Na⁺, and Mg²⁺ in electrodialysis was evaluated using the relative transport numbers ti/Li. These values were determined by dividing the amount of specific cation i transported (e.g., i=Na⁺ and Mg²⁺, in mEq) by the arithmetic average equivalent cation i concentration of initial (concentrate-feeding) and final (concentrate-out) concentrations as opposed to for Li⁺ recovered, where the amount of Li⁺ recovery (in mEq) is divided by the arithmetic average equivalent Li⁺ concentration of the initial and final concentrations.

$$ti / Li = ( Equivalent of i transported / average equivalent i concentration ) / ( Equivalent of Li recovered / average equivalent Li concentration ) \qquad ( 7 )$$

Based on the definition, a lower ti/Li signified higher Li⁺ permselectivity of CEMs. The enhancement in Li⁺ permselectivity was computed as:

$$Permselectivity improvement = {t}_{i / Li} of M 1 / {t}_{i / Li} of M 2 \qquad ( 8 )$$

where, M1=CR671; PDA-CR671; or PEI-CR671; M2=PDA-220 CR671; PEI-CR671; or 15CE/PEI-PDA-CR671.

The Li⁺ flux improvement was calculated as

$$Li flux improvement = Li flux of M 1 / Li flux of M 2 \qquad ( 9 )$$

During electrodialysis, the leakage rate of other cations, denoted as i (i=Mg²⁺, Na⁺), was calculated as:

$$i leaking rate ( \% ) = ( {C}_{out} - {C}_{in} ) / {C}_{in} \times 100 \qquad ( 10 )$$

where, i=Mg²⁺ and Na⁺, Cₒᵤₜ and Cᵢₙ are the i concentration of concentrate-out and concentrate feeding (mg/L), respectively, of the electrodialysis system.

### Example 7

The ATR-FTIR was used to characterize the chemical composition of CR671, PDA-CR671, PEI-PDA-CR671, and 15CE/PEI-PDA-CR671 membranes. The peaks within the range of 3200 cm⁻¹ to 3600 cm⁻¹ were attributed to O—H stretching vibrations. In 15CE/PEI-PDA-CR671, the peaks exhibited intensity owing to the presence of hydroxymethyl (—CH₂OH) groups in 15CE, contributing to the FTIR spectrum. The peaks observed at 2850 cm⁻¹ to 2960 cm⁻¹ corresponded to C—H stretching vibrations, with heightened intensity resulting in 15CE/PEI-PDA-CR671 from the incorporation of 15CE. The prominent nature of these peaks indicated the presence of crown ether on the 15CE/PEI-PDA-CR671 surface.

### Example 8

Zeta potential regulates interactions among charged surfaces in water and mirrors the electrochemical traits of membrane surfaces, impacting the sorption of ions. This sorption is contingent on factors such as membrane composition and the types of electrolytes used, with pH playing a role in zeta potential modulation through ion sorption. In electrodialysis for lithium recovery, zeta potential dictates ion selectivity and transport characteristics crucial for membrane membrane-based processes. The zeta potential of membranes was determined. The CR671 membrane demonstrated a positive charge (5.2 mV) within the pH range of 5 to 7, indicative of a slightly acidic to neutral environment. The membranes (PDA-CR671) modified with PDA exhibited a negatively charged surface, ranging from −41.3 mV to −4.5 mV within the pH range of 5 to 8.6. This negativity stemmed from the deprotonation of amine and phenolic hydroxyl groups, as the isoelectric point of PDA is 4. The PEI coating layer polymerized with BT on both membranes (PEI-PDA-CR671 and 15CE/PEI-PDA-CR671, displaying similar zeta potentials) resulted in a positively charged surface. Within the pH range of 5 to 7, the zeta potentials remained consistently within the range of 43 mV to 100 mV. When the pH exceeded 8 to 9, the zeta potentials increased to approximately 360 mV. In the case of 15CE/PEI-PDA-CR671 membranes, the introduction of 15CE did not exert a significant influence on the zeta potential of the membranes. This positive charge was ascribed to the cationic nature of PEI and its prominently branched structure, pronounced at pH levels below 7. Consequently, despite the incorporation of 15CE, the zeta potential of 15CE/PEI-PDA-CR671 remained comparable to that of PEI-PDA-CR671. This suggested that surface charge may not be the primary factor contributing to the differences in ion transport rates between 15CE/PEI-PDA-CR671 and PEI-PDA-CR671 membranes.

### Example 9

Thermogravimetric analysis (“TGA”) was employed to characterize the membrane properties. The weight loss characteristics of the samples were examined over a temperature range of 35° C. to 700° C., revealing distinct phases at 35° C. to 280° C., 280° C. to 320° C., 320° C. to 430° C., and 430° C. to 700° C. The initial weight loss phase was attributed to the evaporation of water inherent to the samples or the elimination of residual absorbed water. The pronounced initial weight loss observed between 280° C. to 320° C. was associated with the molecular chain cleavage of the polymer in the CR671. Subsequently, in the second rapid weight loss phase (320° C. to 430° C.), the polymer underwent a gradual decomposition process. A stable sample weight characterized the final stage. For CR671, the membranes experienced complete decomposition, leaving only 3.5% of the initial sample weight, indicating the susceptibility of these samples to thermal decomposition with increasing temperature. Following modification, at the ultimate stage, the membranes (PDA-CR671, PEI-PDA-CR671, and 15CE/PEI-PDA-CR671) exhibited approximately 22% retained weight, signifying enhanced thermal stability compared to the unmodified CR671 membranes.

### Example 10

The assessment of modified and pristine CR671 membranes was undertaken using bench-scale electrodialysis system to treat synthetic brine solutions. Prior to initiating the process, limited current densities (“LCD”) were methodically ascertained following the procedures delineated in our prior publication. The subsequent electrodialysis was operated under the measured LCD of 15.9 mA/cm² to ensure the energy efficiency of the system.

### Example 11

In order to systematically scrutinize the efficacy of selective Li separation from brines characterized by an elevated Mg²⁺/Li⁺ ratio, the brine composition by adopting a mass ratio of MgCl₂ and LiCl set at 5:1 (wt./wt.) was replicated. Li⁺ permselectivity of the modified and CR671 membranes was evaluated by analyzing transport numbers (ti), Li⁺ flux, Li⁺ recovery rate, and Mg²⁺ leaking rate in a laboratory-scale electrodialysis stack, considering various applied current densities. The collective data presented in Table 2, shown below, provides insights into Li recovery, permselectivity (expressed as the relative transport number t_{Mg/Li}), current efficiency, and Li flux during experimental trials involving a mixture of MgCl₂ and LiCl.

TABLE 2
Lithium recovery performance and permselectivity for Li⁺ and Mg²⁺ of the
modified and pristine CR671 during bench-scale electrodialysis of brine solutions.

| | | | | | | | Li | Mg | PH of |
|---|---|---|---|---|---|---|---|---|---|
| | Average current | Current | | | | Li Flux | recovery | Leaking | concentrate- |
| Membranes | density(mA/cm²) | efficiency | t_{Li} | t_{Mg} | t_{Mg}/t_{Li} | (meq/s-m²) | rate (%) | rate (%) | out |
| CR671 | 2.19 | 3.89 ± 1.07 | 0.08 | 0.92 | 2.52 | 0.49 ± 0.19 | 0.12 | 0.32 | 8.57 |
| | 9.27 | 7.88 ± 2.53 | 0.22 | 0.78 | 1.45 | 7.00 ± 1.43 | 1.80 | 2.66 | 8.48 |
| | 14.67 | 21.66 ± 7.82 | 0.16 | 0.84 | 2.16 | 20.53 ± 5.94 | 5.36 | 11.95 | 8.38 |
| PDA-CR671 | 2.19 | 34.04 ± 7.47 | 0.07 | 0.93 | 2.57 | 2.97 ± 0.64 | 0.76 | 1.98 | 8.53 |
| | 9.27 | 55.57 ± 9.96 | 0.28 | 0.72 | 1.07 | 51.19 ± 6.83 | 13.17 | 14.22 | 8.45 |
| | 14.67 | 7.97 ± 2.58 | 0.25 | 0.75 | 1.25 | 15.34 ± 2.76 | 3.95 | 4.97 | 8.39 |
| PEI-PDA- | 2.19 | 9.03 ± 1.89 | 0.07 | 0.93 | 3.08 | 5.40 ± 1.21 | 1.31 | 4.08 | 8.56 |
| CR671 | 9.27 | 24.13 ± 4.32 | 0.12 | 0.88 | 3.17 | 14.18 ± 4.86 | 3.43 | 6.29 | 8.47 |
| | 14.67 | 19.38 ± 6.58 | 0.07 | 0.93 | 5.39 | 10.69 ± 3.65 | 2.59 | 8.10 | 8.37 |
| 15CE-PEI- | 2.19 | 38.35 ± 9.88 | 0.84 | 0.16 | 0.08 | 26.74 ± 5.85 | 6.75 | 0.52 | 8.56 |
| PDA-CR671 | 9.27 | 16.99 ± 2.94 | 0.81 | 0.19 | 0.11 | 88.35 ± 15.69 | 22.31 | 2.20 | 8.48 |
| | 14.67 | 39.36 ± 7.37 | 0.85 | 0.15 | 0.10 | 248.58 ± 47.28 | 62.78 | 4.78 | 8.39 |

The pristine CR671 membranes exhibited a lower transport number for Li⁺ and a higher transport number for Mg²⁺, resulting in elevated relative transport numbers t_{Mg/Li} within the range of 2.52 mA/cm² to 2.16 mA/cm² at current densities from 2.19 mA/cm² to 14.67 mA/cm². At the highest current density of 14.67 mA/cm², the CR671 membranes demonstrated a low Li recovery rate (5.4%) and a high Mg leaking rate (12%), indicating a deficiency in Li selectivity. Following polydopamine (PDA) modification, the PDA-CR671 membranes exhibited comparable transport numbers with CR671 for Li⁺ and Mg²⁺, with a reduction in the relative transport number t_{Mg/Li} at 14.67 mA/cm². At a current density of 9.27 mA/cm², Li recovery rate (13.2%) and Mg leaking rate (14.22%) increased. At the same high current density of 9.27 mA/cm², the PDA-CR671 membranes displayed an augmented Li flux (51.2 mEq/s·m²) compared to CR671 (7.00 mEq/s·m²) and PEI-PDA-CR671 (14.2 mEq/s·m²), attributed to heightened hydrophilicity resulting from PDA modification. Concerning the PEI-PDA-CR671 membranes, all relative transport numbers t_{Mg/Li} surpassed those of CR671 and PDA-CR671 while concurrently exhibiting a lower Li recovery rate (3.4%) and Mg leaking rate (8.1%) compared to CR671 and PDA-CR671. This observation suggested reduced permeability due to polyethyleneimine (“PEI”) cross-linking, inducing substantial electric repulsion toward cations such as Li and Mg, leading to diminished permeability. The modified 15CE/PEI-PDA-CR671 membranes, incorporating 15CE, demonstrated the highest transport numbers for Li (0.84, 0.81, 0.85) and the lowest for Mg (0.16, 0.19, 0.15) across varying current densities. The relative transport numbers t_{Mg/Li} ranged from 0.08 to 0.10, the lowest among the four membranes, indicating superior permselectivity for Li. The membranes exhibited the highest Li flux (248.6 molar equivalent (“mEq”)/s·m²) at the current density of 14.67 mA/cm², and the highest Li recovery rate (62.8%) and the lowest Mg leaking rate (4.8%) suggested that 15CE-modified membranes selectively separated Li from solutions with higher Mg/Li ratios.

### Example 12

In the saline solution, the presence of Na⁺ as the competing cationic ion is a primary challenge for the selective Li recovery processes. To systematically evaluate the efficacy of selectively extracting Li from brines characterized by a saline milieu, Mg²⁺ brine composition by establishing a mass ratio of NaCl to LiCl at 5:1 (wt./wt.) was replicated. The assessment of Li⁺ permselectivity for the membranes involved the analysis of transport numbers (t), Li⁺ flux, Li⁺ recovery rate, and Na⁺ leaking rate in a bench-scale electrodialysis stack at various applied current densities. Table 3, shown below, presents the collective data on Li recovery, permselectivity (expressed as the relative transport number t_{Na/Li}), current efficiency, and Li flux during experimental trials involving a mixture of NaCl and LiCl (5:1, wt./wt.).

TABLE 3
Lithium recovery performance and permselectivity for Li+ and Na+ of
the modified and pristine CR671 during bench-scale electrodialysis of brine solutions.

| | | | | | | | | | pH of |
|---|---|---|---|---|---|---|---|---|---|
| | Average current | Current | | | | Li Flux | Li recovery | Na Leaking | concentrate- |
| Membranes | density(mA/cm²) | efficiency | t_{Li} | t_{Na} | t_{Na}/t_{Li} | (meq/s-m²) | rate (%) | rate (%) | out |
| CR671 | 2.30 | 3.89 ± 0.54 | 0.10 | 0.90 | 2.34 | 6.54 ± 1.26 | 1.49 | 3.52 | 8.36 |
| | 9.40 | 7.88 ± 1.28 | 0.14 | 0.86 | 1.65 | 14.07 ± 2.68 | 3.20 | 5.33 | 8.24 |
| | 15.90 | 21.66 ± 4.56 | 0.15 | 0.85 | 1.53 | 19.50 ± 6.85 | 4.44 | 6.87 | 8.14 |
| PDA-CR671 | 2.30 | 34.04 ± 7.68 | 0.22 | 0.78 | 1.01 | 23.34 ± 3.75 | 3.58 | 3.61 | 8.41 |
| | 9.40 | 55.57 ± 8.36 | 0.21 | 0.79 | 1.05 | 33.32 ± 6.37 | 5.11 | 5.39 | 8.23 |
| | 15.90 | 7.97 ± 7.74 | 0.11 | 0.89 | 2.11 | 44.49 ± 8.34 | 28.13 | 30.91 | 8.14 |
| PEI-PDA- | 2.30 | 57.22 ± 7.46 | 0.02 | 0.98 | 14.03 | 3.03 ± 0.65 | 0.52 | 7.54 | 8.37 |
| CR671 | 9.40 | 20.21 ± 3.18 | 0.06 | 0.94 | 4.56 | 12.56 ± 3.58 | 2.16 | 10.23 | 8.25 |
| | 15.90 | 23.46 ± 4.16 | 0.03 | 0.97 | 10.13 | 10.88 ± 5.58 | 1.87 | 20.68 | 8.13 |
| 15CE-PEI- | 2.30 | 26.17 ± 3.88 | 0.32 | 0.68 | 0.61 | 23.09 ± 3.74 | 5.13 | 3.09 | 8.40 |
| PDA-CR671 | 9.40 | 22.65 ± 2.94 | 0.28 | 0.72 | 0.76 | 36.95 ± 7.34 | 8.21 | 6.18 | 8.25 |
| | 15.90 | 38.66 ± 7.37 | 0.24 | 0.76 | 0.93 | 129.66 ± 14.68 | 28.80 | 26.61 | 8.15 |

The pristine CR671 membranes manifested a lower transport number for Li⁺ and a higher transport number for Na⁺, resulting in elevated relative transport numbers t_{Na/Li} within the range of 2.34 to 1.53 at current densities from 2.30 to 15.90 mA/cm². At the highest current density of 15.90 mA/cm², the CR671 membranes exhibited a low Li⁺ recovery rate (4.44%) and Na⁺ leaking rate (6.87%), indicating deficiencies in Li⁺ permselectivities and permeabilities for the competitor ions. The PDA-CR671 membranes displayed comparable transport numbers with CR671 for Li⁺ and Na⁺, featuring a higher relative transport number t_{Na/Li} of 2.11 compared to CR671 at 15.90 mA/cm². At the highest current density of 15.90 mA/cm², both the Li recovery rate (28.1%) and Na leaking rate (30.9%) increased, and the membranes showed an improved Li flux (44.49 mEq/s·m²) compared to CR671 (19.5 mEq/s·m²) and PEI-PDA-CR671 (10.9 mEq/s·m²). Concerning the PEI-PDA-CR671 membranes, all relative transport numbers t_{Na/Li} surpassed those of CR671 and PDA-CR671 while concurrently exhibiting a lower Li recovery rate (2.2%) and Na leaking rate (10.2%) compared to CR671 and PDA-CR671 at various current densities. This observation suggested reduced permeability due to the increased surface charge measured by zeta potential. The modified 15CE/PEI-PDA-CR671 membranes exhibited the highest transport numbers for Li (0.32, 0.28, 0.24) and the lowest for Na (0.68, 0.72, 0.76) at the various current densities. The relative transport numbers t_{Na/Li} ranged from 0.61 to 0.93, the lowest among the four membranes, indicating superior permselectivity for Li. The membranes exhibited the highest Li flux (129.7 mEq/s·m²) at the current density of 15.90 mA/cm² and a comparable Li recovery rate (28.8%) and Na leaking rate (26.6%), suggesting that 15CE-modified membranes could concentrate the cationic ions from the saline solution.

### Example 13

To assess the sustained efficacy of the membranes over an extended time, an analysis of permselectivity was conducted at the maximum current density of 14.97 for Mg and Li and 15.90 mA/cm² for Na and Li for additional 4 hours (after 3 hours of electrodialysis at different current densities). After an additional 4 hours of electrodialysis for Mg and Li solutions, CR671 and PDA-CR671 exhibited a reduction in lithium recovery. In contrast, 15CE/PEI-PDA-CR671 demonstrated significant Li flux (318.7 mEq/s·m²), a relative transport number t_{Mg/Li} of 0.1, an increased lithium recovery rate of 80.5%, and a Mg leaking rate of 5.8%. The mixture of Na⁺ and Li⁺, CR671 displayed a negative Li recovery rate (indicated by negative signs −), suggesting the membrane was easily fouled. Post-modification, 15CE/PEI-PDA-CR671 consistently exhibited elevated Li flux (407.5 mEq/s·m²) and a high Li recovery rate of approximately 90.5%.

### Example 14

These experiments addressed the challenges of selective extraction of Li⁺ from highly saline solutions, particularly in the presence of competing ions such as Mg²⁺ and Na⁺. The utilization of an interfacial polymerization with the 15CE successfully enhanced the Li⁺selective transport capabilities of commercial CEM (CR671). The two-layer coating strategy, involving PDA as the initial layer and subsequent coating with PEI along with the incorporation of 15CE, established specific channels for efficient Li transport over competing cations Mg²⁺ and Na⁺ in brine solutions. Characterization techniques, including ATR-FTIR and zeta-potential analysis, validated the presence of 15CE coating on the modified membranes (15CE-PEI-PDA-CR671). Following the modification, a reduction in membrane water uptake was evident, mitigating the influence of water molecules on Li⁺ transport. EIS demonstrated decreased impedance for 15CE-PEI-PDA-CR671, indicating its improved Li⁺ transport potential. The permselectivity of the membranes measured during bench-scale electrodialysis experiments under high Mg²⁺ and Na⁺ conditions, showed promising performance using 15CE-PEI-PDA-CR671, achieving Li⁺ recoveries of up to 80% and 90% in Mg²⁺/Li⁺ and Na⁺/Li⁺ mixtures, respectively. The modified membranes exhibited significant improvements in Li⁺ permselectivity and flux compared to unmodified CR671 and PEI-PDA-CR671. Specifically, 15CE-PEI-PDA-CR671 demonstrated a 38.91-fold improvement in Li⁺ permselectivity and a 55-fold improvement in Li⁺ flux compared to CR671 for Mg²⁺/Li⁺ solutions. In contrast, for Na⁺/Li⁺ solutions, the same membrane exhibited a 23.05-fold improvement in Li⁺ permselectivity and a 7.63-fold improvement in Li⁺ flux when compared to PEI-PDA-CR671. It is significant that the membranes exhibited higher permselectivity for Mg²⁺/Li⁺ compared to Na⁺/Li⁺.

### Example 15

CR671 cation exchange membrane was modified with different CEs. The initial step involved preparing a 2 g/L dopamine solution in a Tris-HCl buffer within a pH range of 8.5 to 8.8. PDA formation was indicated by a shift in solution color to brown. Subsequently, CR671 membranes were immersed vertically in the PDA solution at room temperature for 4 hours, named PDA-CR671. Then, PEI, Na₂CO₃, SDS, and various CEs (2-(hydroxymethyl)-12-crown-4 ether, 2-(hydroxymethyl)-18-crown-8 ether, 2-(hydroxymethyl)-15-crown-5 ether) were individually added to deionized (“DI”) water, with magnetic stirring for 30 min to facilitate the binding of CEs and PEI through hydrogen bonds. The resulting solution was then applied onto the surface of PDA-CR671, which had been thoroughly rinsed multiple times using DI water for 10 min. Finally, a crosslinker, BT, was employed to crosslink PEI through water-bathing at 40° C. for 15 minutes, yielding membranes denoted as 12CE/PEI-PDA-CR671, 15CE/PEI-PDA-CR671, and 18CE/PEI-PDA-CR671. The control membranes without CE were named PEI-PDA-CR671.

### Example 16

Preceding characterization, membranes with a 4 cm² area were sectioned and dried in an oven at 40° C. overnight. The structural characteristics and chemical compositions of the membranes were characterized through an attenuated total reflectance Fourier transform infrared spectroscopy (“ATR-FTIR”). The thermal stability of the membranes was examined through Thermogravimetric Analysis (“TGA”).

### Example 17

Recognizing the significance of surface charge, conductivity, and cell resistance of the membranes in the ion transport process during electrodialysis, zeta potential analysis was conducted. To eliminate the residual substances from the membranes resulting from the modification process, the membranes were immersed in DI water for approximately 24 hours. During the testing, 0.1 M NaOH or HCl solutions were employed to regulate the pH, with 0.01 M KCl as the electrolyte. The target pressure for measurements was set at 400 mbar.

### Example 18

Ion exchange capacity (“IEC”) is a significant attribute of ion exchange membranes, indicating the overall count of active sites or functional groups. IEC quantified the number of functional groups per unit of membranes available for transporting ions. In the measurement of IEC, small pieces were cut from 5 cm² to 10 cm² membranes. These membrane fragments were immersed in a 200 mL solution of 1M NaCl for 24 hours using a shaker to ensure the saturation of membranes with Na⁺. Following this, the membranes were transferred to a 100 mL solution of 0.1M KCl to facilitate the exchange of Na⁺ ions from the membranes. After 24 hours, a fresh 0.01M KCl solution was replaced to exchange Na⁺ further by K⁺. This replenishment procedure was repeated three times to entirely replace Na⁺ with K⁺. Samples were collected from each KCl solution to analyze the total concentration of Na⁺replaced from the membranes. The concentration of Na⁺ was determined using an ion chromatograph.

### Example 19

The water adsorption capacities of the CEM membranes play an important role in influencing ion transport during the electrodialysis process. The water adsorption of membranes may vary across different mediums. To assess the water adsorption capacities, the membranes were soaked in synthesized brines and DI water, and the difference in weights before and after exposure to the medium was measured. The membranes were cut into 2 cm² and dried in an oven for 24 hours at 40° C. The dried membranes were weighed and then immersed in either a MgCl₂ and LiCl mixture with a molar ratio of 2.2 (equivalent to a mass ratio of 5) or a NaCl and LiCl mixture with a molar ratio of 3.6 (equivalent to a mass ratio of 5). After 24 hours, the membranes were re-weighed, and the excess surface water was removed using filter papers. The water uptake (“WU”) calculation entailed measuring the weight difference before and after exposure to the medium, followed by normalization with respect to the initial weight.

### Example 20

The electrical resistance of membranes was analyzed by electrochemical impedance spectroscopy (“EIS”) employing a four-electrode method. The frequency range applied spanned from 10,000 Hz to 0.001 Hz, operating under alternating current. The modified membrane samples with an effective area of 0.8 cm², were placed between two compartments, each filled with 12.5 mL electrolyte solutions, including three different concentration solutions of 0.1 M MgCl₂, NaCl, and LiCl; 0.02 M LiCl, MgCl₂, NaCl; and 0.1 M LiCl, MgCl₂ and NaCl. The membrane samples underwent 24 hours conditioning through immersion in 0.1 M KCl solution before any experimentation. The time of ion transport through the interface between the surface coating and the membrane was determined by examining impedance spectra at the frequency impedance peak (fₘₐₓ) utilizing Eq (2).

$$τ = 1 / ( 2 π {f}_{max} ) \qquad ( 2 )$$

### Example 21

Bench-scale electrodialysis and calculations were performed. The performance of three modified, Li⁺ selective CEMs was systematically evaluated using a bench-scale electrodialysis system under controlled conditions. The operation parameters are shown in Table 4.

TABLE 4
Electrodialysis stack specifications and operational parameters

| Component | Type | Characteristics |
|---|---|---|
| EDR stack | Single stage | Electrode: Pt/Ir-MMO-coated Ti |
| | | processing length: 2.8 cm |
| IEMs | CEMs | CR671, PDA-CR671, |
| | | PEI-PDA-CR671 |
| | | 12CE/PEI-PDA-CR671 |
| | | 15CE/PEI-PDA-CR671 |
| | | 18CE/PEI-PDA-CR671 |
| | AEMs | AR204-SZRA-412 |
| Effective membrane | | 8 cm² |
| area | | |
| Spacer thickness | Gasket | 0.32 mm |
| Volumetric flow | Diluate and | 180 mL/min (33.5 cm/s) |
| rate | concentrate | |
| (linear velocity) | Electrode rinse | 180 mL/min (33.5 cm/s) |

The feed solution comprised a 4 L volume containing Na⁺/Li⁺ or Mg²⁺/Li⁺ mixtures prepared with tap water. Brines from locations like West Tajinier Salt Lake in western China exhibited specific characteristics, with Li⁺, Mg²⁺, and Na⁺ concentrations at 2.2 g/L, 118 g/L, 1.0 g/L, and a Mg²⁺/Li⁺ mass ratio of 53. In instances where the Mg²⁺/Li⁺ mass ratio exceeded 5, lime was to be used to reduce the mass ratio of Mg²⁺/Li⁺ to below 5. A Mg²⁺/Li⁺ solution was prepared with a molar ratio of 2.2 (equivalent to a mass ratio of 5) or a Na⁺/Li⁺ solution with a molar ratio of 3.6 (equivalent to a mass ratio of 5) to assess the performance and permselectivity of the modified membranes in Na-rich or Mg-rich brines. As an electrode rinse, a 2 wt. % Na₂SO₄ solution was employed. The electrodialysis system was equipped with ten pairs of IEMs, which included eleven modified CEMs and ten anion-exchange membranes (“AEMs”). The experimental setup operated in continuous flow mode, with feed/diluate and concentrate streams recirculated to the feed solution tank. The flow rates for both feed and concentrate streams were controlled at 180 mL/min, maintaining a linear flow velocity of 33.5 cm/s. The efficient surface area was 8 cm² (details are shown in Table 5). Throughout the bench-scale testing, the applied current density consistently adhered to values below the initially measured limiting current density, which was determined at the commencement of the experiments upon membrane installation. Water samples were collected every hour to measure Li⁺, Mg²⁺, and Na⁺ concentrations.

TABLE 5
Conductivity and cell resistance of the membranes

| | | Conductivity | Cell resistance |
|---|---|---|---|
| Membranes | pH | (mS/m) | (KOhm) |
| CR671 | 8.57 | 15.1 | 22.3 |
| 12CE/PEI-PDA-CR671 | | 15.7 | 20.4 |
| 15CE/PEI-PDA-CR671 | | 16.5 | 18.8 |
| 18CE/PEI-PDA-CR671 | | 15.8 | 20.1 |

As part of the investigation, the current efficiency of electrodialysis was calculated as:

$$Current efficiency ( \% ) = \frac{\sum Fqz ( {C}_{in} - {C}_{out} )}{NI} \times 100 \qquad ( 4 )$$

where, F represents the Faraday constant (96,485 C/mol), q indicates the flow rate of concentrate-out (L/s), Cᵢₙ and Cₒᵤₜ refer to the concentrations of concentrate-in and concentrate-out of the ions (mol/L), z denotes the charge of the ion, N represents the number of membrane cell pairs, and I is the applied current in Amperes (“Amp”).

The Li flux (mEq/s·m²), was calculated as follows:

$$Li flux = \frac{Equivalent of Li recovered \times flow rate}{Effective membrane surface area} \qquad ( 5 )$$

The efficiency of lithium recovery was calculated using Eq (3).

$$Li recovery ( \% ) = ( {C}_{out} - {C}_{in} ) / {C}_{in} \times 100 \qquad ( 3 )$$

where, Cₒᵤₜ and Cᵢₙ are the lithium concentration of concentrate-out and concentrate-in (mg/L), respectively, of the electrodialysis system.

The desalination efficiency of electrodialysis was calculated based on the conductivity reduction (Eq.11):

$$Conductivity reduction ( \% ) = ( 1 - \frac{{EC}_{d}}{{EC}_{f}} ) \times 100 \qquad ( 11 )$$

where, EC_{d} and EC_{f} are the electrical conductivity of diluate-out and feed-in (in mS/cm), respectively, of the electrodialysis system.

During electrodialysis, the leakage rate of other cations denoted as A (A=Mg²⁺, Na⁺), was calculated as:

$$A leaking rate ( \% ) = \frac{{C}_{out} - {C}_{in}}{{C}_{in}} \times 100 \qquad ( 12 )$$

where, A=Mg²⁺ and Na⁺, Cₒᵤₜ and Cᵢₙ are the A concentration of concentrate-out and concentrate-in (mg/L), respectively, of the electrodialysis system.

The transport number was used to determine the transfer of specific cations A (i.e. Na⁺, Mg²⁺, or Li⁺).

$${t}_{A} = \frac{Equivalent of A transported}{Equivalent of total cations transported} \qquad ( 13 )$$

The assessment of membrane permselectivity for Li⁺, Na⁺, and Mg²⁺ in electrodialysis involved the calculation of relative transport numbers (t_{A/Li}). These values were derived by dividing the quantity of the specific cation A transported (e.g., A=Na⁺ and Mg²⁺, in mEq) by the arithmetic average equivalent cation A concentration at both the initial (concentrate-in) and final (concentrate-out) stages. In contrast, for Li⁺, the calculation involved dividing the amount of Li⁺ recovered (in mEq) by the arithmetic average equivalent Li⁺ concentration at the initial and final concentrations.

$${t}_{A / Li} = \frac{( Equivalent of A transported / average equivalent A concentration )}{( Equivalent of Li recovered / average equivalent Li concentration )} \qquad ( 14 )$$

Modified CEMs with lower t_{A/Li} exhibit higher Li⁺ permselectivity, and the enhancement in Li⁺ permselectivity was calculated using the formula Eq (15).

$$Permselectivity improvement = \frac{{t}_{A / Li} of {M}_{1}}{{t}_{A / Li} of {M}_{2}} \qquad ( 15 )$$

where, M₁=12CE/PEI-PDA-CR671 or 18CE/PEI-PDA-CR671; M₂=12CE/PEI-PDA-CR671, 15CE/PEI-PDA-CR671 or 18CE/PEI-PDA-CR671.

The improvement in Li⁺ flux was calculated as:

$$Li flux improvement = \frac{Li flux of {M}_{1}}{Li flux of {M}_{2}} \qquad ( 9 )$$

The efficiency of Li⁺ recovery is influenced by current, voltage, and overall effective membrane area. The normalized Li⁺ recovery was determined by assessing the mass of recovered lithium (in mg) per unit of electrical energy consumed per the total membrane area (in square centimeters, cm²).

$$Normalized Li recovery = \frac{( {C}_{out} - {C}_{in} ) \times V}{I \times Volt \times A} \qquad ( 16 )$$

where, Cₒᵤₜ and Cᵢₙ are the lithium concentration of concentrate-out and concentrate-in (mg/L) of the electrodialysis system, V is the volume of the concentrate-feed tank (L), I and Volt are the current density (Amp) and voltage applied in the system (Volt), A is the total effective area of the 10 pairs membranes in the stack (80 cm²).

### Example 22

Electrochemical impedance spectroscopy (“EIS”) presented numerous advantages owing to its inherent characteristics as a steady-state technique, utilization of small signal analysis, and the capacity to investigate signal relaxations across a wide range of applied frequencies spanning from 0.001 Hz to 100,000 Hz. This capability was facilitated through the utilization of readily available electrochemical working stations.

### Example 23

A key consideration was the potential impact of various cationic ions competing with Li⁺ on the efficient Li⁺ recovery in electrodialysis. Among these ions, Mg²⁺ in brines posed a distinct challenge due to the similarity in the hydrated ions of Mg²⁺ and Li⁺, leading to complications in their effective separation during electrodialysis. Additionally, considering factors such as approximate ion radius and valence state, Na⁺ was identified as another competitor for Li⁺ in this investigation. Consequently, distinct brine solutions with Mg²⁺ or Na⁺ were systematically investigated regarding the influence of competing ions on the permselectivity of the modified membrane throughout the electrodialysis process. In this study, brine solutions consisting of a mixture of MgCl₂ and LiCl in a 2.2 (mole/mole) ratio, along with NaCl and LiCl in a 3.6 (mole/mole) ratio, were synthesized to use in a bench-scale electrodialysis system.

Before experimentation, the limited current density (LCD) was determined following the methodology outlined in our previous study. When testing the three membranes in Na⁺ and Li⁺, and Mg²⁺ and Li⁺ solutions, a linear correlation was observed between voltage per cell-pair and current density within the 2.3 mA/cm² to 29.5 mA/cm² range. The electrodialysis process was executed under the LCD, with current densities set at 14.7 mA/cm² for Mg/Li solutions and 15.9 mA/cm² for Na/Li solutions.

The samples were collected from feed solutions before the electrodialysis and the diluate-out and concentrate-out were analyzed at different current densities (2.3 mA/cm², 9.4 mA/cm², and 15.9 mA/cm² for Na⁺ and Li⁺ solution or 2.2 mA/cm², 9.3 mA/cm², and 14.7 mA/cm² for Mg²⁺ and Li⁺ solution) at one-hour intervals. After 3 hours of electrodialysis, an additional 4 hours were applied to assess the persistence of the membranes in the saline solutions at the highest current density of 15.9 mA/cm² for Na⁺/Li⁺ solution and 14.7 mA/cm² for Mg²⁺/Li⁺ solution, which noted as 15.9-4 and 14.7-4. For these terms, in the first three hours, three different current densities were used to analyze the performance. After three hours, the membranes were at the highest current density for Li recovery for an additional four hours. To differentiate from the first three hours' performance, 15.9-4 mA/cm² and 14.7-4 mA/cm² were used for the persistence analysis of the membranes. During electrodialysis, the potential drops were observed during Li recovery from Mg²⁺ and Li⁺ solution and Na⁺ and Li⁺ solution at an average of 12.0 V/h at a current density of 14.7 mA/cm² and 15.9 mA/cm² for the three membranes.

### Example 24

In brines, separating Li⁺ from a Na-rich solution proved to be more challenging compared to a high Mg²⁺ and Li⁺ brine. This difficulty stemmed from the similar univalent nature of Na⁺ and Li⁺ ions and their lower separation coefficients associated with Na⁺. To systematically assess Li⁺ recovery efficiency, modified membrane performance, and permselectivity, a Na-rich solution was prepared at a molar ratio of 3.6 and was treated using the bench-scale electrodialysis stack. The evaluation criteria included Li⁺ flux, Li recovery efficiency, relative transport number (t_{Na/Li}), and Na⁺ leaking rate, as detailed in Table 6, shown below.

TABLE 6
The permselectivity and performance of the modified membranes for
the Li recovery from Na⁺/Li⁺ solution (3.6 mole/mole)

| | Average | | | | | | | | |
|---|---|---|---|---|---|---|---|---|---|
| | current | Current | | | | | Li recovery | | pH of |
| | density | efficiency | | | | Li Flux | efficiency | Na Leaking | concentrate- |
| Membranes | (mA/cm²) | (%) | t_{Li} | t_{Na} | t_{Na}/t_{Li} | (meq/s-m²) | (%) | rate (%) | out |
| 12CE-PEI- | 2.3 | 20.3 ± 3.9 | 0.12 | 0.88 | 2.00 | 4.7 ± 1.2 | 0.84 | 1.7 | 8.42 |
| PDA-CR671 | 9.4 | 14.8 ± 2.8 | 0.26 | 0.74 | 0.81 | 34.3 ± 5.7 | 11.1 | 4.9 | 8.27 |
| | 15.9 | 17.3 ± 1.6 | 0.25 | 0.75 | 0.85 | 62.3 ± 9.8 | 17.4 | 9.4 | 8.17 |
| | 15.9-4 | 35.8 ± 8.5 | 0.25 | 0.75 | 0.88 | 126.9 ± 11.4 | 22.7 | 19.6 | 8.16 |
| 15CE-PEI- | 2.3 | 38.4 ± 3.9 | 0.32 | 0.68 | 0.61 | 23.1 ± 3.7 | 5.1 | 3.1 | 8.40 |
| PDA-CR671 | 9.4 | 17.0 ± 2.9 | 0.28 | 0.72 | 0.76 | 37.0 ± 7.3 | 8.2 | 6.2 | 8.25 |
| | 15.9 | 39.4 ± 7.4 | 0.24 | 0.76 | 0.93 | 129.7 ± 14.7 | 28.8 | 26.6 | 8.15 |
| | 15.9-4 | 127.4 ± 6.3 | 0.23 | 0.77 | 0.97 | 407.5 ± 21.5 | 90.5 | 86.9 | 8.14 |
| 18CE-PEI- | 2.3 | 80.3 ± 8.5 | 0.21 | 0.79 | 1.06 | 32.3 ± 5.7 | 6.6 | 7.0 | 8.41 |
| PDA-CR671 | 9.4 | 19.3 ± 3.9 | 0.23 | 0.77 | 0.96 | 42.6 ± 7.8 | 8.6 | 8.3 | 8.26 |
| | 15.9 | 17.8 ± 4.0 | 0.19 | 0.81 | 1.15 | 79.1 ± 9.4 | 16.0 | 18.7 | 8.17 |
| | 15.9-4 | 33.4 ± 5.0 | 0.17 | 0.83 | 1.30 | 117.4 ± 11.4 | 23.8 | 32.2 | 8.15 |

### Example 25

Table 6 presents the ion transfer numbers (t_{Li} and t_{Na}) for membranes 12CE/PEI-PDA-CR671 and 18CE/PEI-PDA-CR671 at different current densities. At a current density of 15.9 mA/cm², t_{Li} and t_{Na} were determined to be 0.25 and 0.75 for 12CE/PEI-PDA-CR671 and 0.19 and 0.81 for 18CE/PEI-PDA-CR671, respectively. At the same current density of 15.9 mA/cm², the relative transfer numbers (t_{Na/Li}) for 12CE/PEI-PDA-CR671 and 18CE/PEI-PDA-CR671 were calculated as 0.85 and 1.15, indicating that 12CE/PEI-PDA-CR671 (similar to 15CE/PEI-PDA-CR67) selectively separated and concentrated Li⁺ from Na⁺/Li⁺ solutions. As both time and current density increased, there was an observed rise in Li⁺ recovery efficiency for the three modified membranes. At a current density of 15.9 mA/cm², the Li⁺ recovery efficiency for 12CE/PEI-PDA-CR671 and 18CE/PEI-PDA-CR671 was 17.4% and 16%, respectively, significantly lower than the Li⁺ recovery efficiency of 15CE/PEI-PDA-CR671 (90.5%). Although the Na⁺ leaking rates were observed as 9.4% and 18.7%, respectively, and 18CE/PEI-PDA-CR671 showed that the Na⁺ leaking rate surpassed the Li⁺ recovery efficiency, implying that despite effectively concentrating Li⁺, there is a concurrent concentration of Na⁺. This was attributed to the growth of moisture content in membranes, promoting a simultaneous increase of conductivity and a decrease in the selectivity of transport processes, along with the stronger hydration ability of Li⁺ relative to Na⁺. Among the three modified membranes, 12CE/PEI-PDA-CR67 and 18CE/PEI-PDA-CR671 exhibited lower Li⁺ recovery efficiency and Li⁺ flux (62.3 and 79.1 mEq/s·m²) at a current density of 15.9 mA/cm², along with a current efficiency of 17.3% and 17.8%, respectively, compared to those of 15CE/PEI-PDA-CR671 (39.4%). The normalized Li⁺ recovery efficiency for 12CE/PEI-PDA-CR671 and 18CE/PEI-PDA-CR671, at a current density of 2.3 mA/cm², was 3.8 and 23.6 g/kWh-cm², respectively. The conductivity reduction observed for 12CE/PEI-PDA-CR671 and 18CE/PEI-PDA-CR671 was 15.3 and 14.8%, respectively, lower than that of 15CE/PEI-PDA-CR671.

After an additional 4 hours of experimentation, the modified membranes demonstrated increased Li⁺ transport permeability in Na-rich brines. The membranes 12CE/PEI-PDA-CR671 and 18CE/PEI-PDA-CR671 showed Li recovery efficiency of 22.7% and 23.8%, which are lower than that of 15CE/PEI-PDA-CR671 (90.5%). The Li⁺ flux of 12CE/PEI-PDA-CR671 and 18CE/PEI-PDA-CR671 was 126.9 and 117.4 mEq/s·m² with the current efficiency of 35.8% and 33.4%, respectively, lower than that of 15CE/PEI-PDA-CR671 (407.5 mEq/s·m²) with higher current efficiency of 127.4%, indicating that 15CE/PEI-PDA-CR671 possesses a higher permselectivity for Li⁺ than that of 12CE/PEI-PDA-CR671 and 18CE/PEI-PDA-CR671. These results suggested that the modified membranes with CEs enhanced the persistence in Na-rich brines.

In altering the membrane by incorporating diverse CEs, the resultant modified membranes demonstrated varying permselectivity for Li⁺ and Na⁺ ions. Factors contribute to these distinctions. Firstly, the distinct cavity sizes and hydrated radii of the three different CEs and alkali ions (Mg²⁺>Li⁺>Na⁺) contributed to the divergent permselectivity measured in the modified membranes. The 12CE/PEI-PDA-CR671 and 15CE/PEI-PDA-CR67 configurations exhibited selectivity for Li⁺ over Na⁺ due to the congruence between the hydrated Li⁺ radius and the cavity diameter of 12CE (1.2 Å to 1.5 Å) and 15CE (1.7 Å to 2.2 Å). Conversely, 18CE/PEI-PDA-CR67 demonstrated selectivity for Na⁺ over Li⁺ due to the incongruity between the hydrated Li⁺ radius and the cavity diameter of 18CE (2.6 Å to 3.2 Å). Secondly, the observed thermodynamic contrast between the 15CE/Li complex (log kₐ=0) and the 15CE/Na complex (log kₐ=0.44) underscored distinct energetic characteristics in the interactions with Li⁺ and Na⁺, respectively. This disparity in thermodynamic values implied varying affinities and stability for the formed complexes. The inherent instability of the Li-15 CE complex suggested a less favorable binding environment, resulting in a selective advantage of 15CE/PEI-PDA-CR671 for Li⁺. Thirdly, the higher distribution coefficient of Li⁺ compared to Na⁺ in the solution resulted in a greater potential of Li⁺ to contact with or reaching the membranes (12CE/PEI-PDA-CR671), leading to a higher potential permselectivity for Li⁺ over Na⁺. Fourthly, the elevated water uptake, coupled with the establishment of a stable complex between 18CE and H₃O⁺, collectively diminished the selectivity of the 18CE/PEI-PDA-CR671 system for Li⁺, thereby facilitating the permeation of Na⁺ through the membranes more readily than Li⁺.

### Example 26

In brines, the presence of multivalent ions, like Mg²⁺, competed with Li⁺ during the separation process. This competition was attributed to the similar hydrated ion sizes of Mg²⁺ and Li⁺. A Mg²⁺/Li⁺ brine with a ratio of 3.6 mole/mole was utilized to assess the permselectivity and effectiveness of the modified membranes. The performance data for the membranes are summarized in Table 7, shown below.

TABLE 7
The permselectivity and performance of the modified membranes for the
Li recovery from Mg²⁺/Li⁺ solution (2.2 mole/mole).

| | Average | | | | | | | | |
|---|---|---|---|---|---|---|---|---|---|
| | current | | | | | | Li recovery | Mg | pH of |
| | density | Current | | | | Li Flux | efficiency | Leaking | concentrate- |
| Membranes | (mA/cm²) | efficiency | t_{Li} | t_{Mg} | t_{Mg}/t_{Li} | (meq/s-m²) | (%) | rate (%) | out |
| 12CE-PEI- | 2.2 | 19.6 ± 4.3 | 0.51 | 0.49 | 0.20 | 16.5 ± 1.3 | 4.7 | 0.9 | 8.53 |
| PDA-CR671 | 9.3 | 15.3 ± 1.6 | 0.77 | 0.23 | 0.13 | 71.3 ± 6.7 | 20.0 | 2.4 | 8.45 |
| | 14.7 | 20.0 ± 5.3 | 0.73 | 0.27 | 0.18 | 121.5 ± 12.7 | 34.1 | 5.3 | 8.41 |
| | 14.7-4 | 21.2 ± 4.2 | 0.71 | 0.29 | 0.20 | 155.0 ± 16.3 | 43.6 | 7.2 | 8.39 |
| 15CE-PEI- | 2.2 | 38.4 ± 9.9 | 0.84 | 0.16 | 0.08 | 26.7 ± 5.9 | 6.8 | 0.5 | 8.56 |
| PDA-CR671 | 9.3 | 17.0 ± 2.9 | 0.81 | 0.19 | 0.11 | 88.4 ± 15.7 | 22.3 | 2.2 | 8.48 |
| | 14.7 | 39.4 ± 7.4 | 0.85 | 0.15 | 0.10 | 248.6 ± 47.3 | 62.9 | 4.8 | 8.39 |
| | 14.7-4 | 49.7 ± 9.3 | 0.74 | 0.26 | 0.10 | 318.7 ± 55.6 | 80.5 | 5.7 | 8.37 |
| 18CE-PEI- | 2.2 | 30.9 ± 4.3 | 0.48 | 0.52 | 0.21 | 24.2 ± 5.7 | 6.5 | 1.3 | 8.53 |
| PDA-CR671 | 9.3 | 11.7 ± 3.4 | 0.67 | 0.33 | 0.20 | 54.8 ± 6.8 | 14.7 | 2.8 | 8.46 |
| | 14.7 | 12.7 ± 2.8 | 0.74 | 0.26 | 0.15 | 109.8 ± 11.8 | 29.5 | 3.9 | 8.41 |
| | 14.7-4 | 19.3 ± 4.9 | 0.75 | 0.25 | 0.14 | 140.0 ± 18.6 | 37.6 | 4.7 | 8.39 |

Table 7 presents the ion transfer numbers (t_{Li} and t_{Mg}) for membranes 12CE/PEI-PDA-CR671, 15CE/PEI-PDA-CR671, and 18CE/PEI-PDA-CR671 at different current densities. At a current density of 14.7 mA/cm², the values for t_{Li} and t_{Mg} were 0.73 and 0.21 for 12CE/PEI-PDA-CR671 and 0.74 and 0.26 for 18CE/PEI-PDA-CR671, respectively. The relative transfer numbers (t_{Mg/Li}) at the same current density were calculated as 0.18 for 12CE/PEI-PDA-CR671 and 0.15 for 18CE/PEI-PDA-CR671, indicating selective separation of Li⁺ from Mg-rich solutions, similar to 15CE/PEI-PDA-CR67. With increasing time and current density, there was an observed increase in Li⁺ recovery efficiency for all three modified membranes. At a current density range of 14.7 mA/cm², the Li⁺ recovery efficiency for 12CE/PEI-PDA-CR671 and 18CE/PEI-PDA-CR671 was 34.1% and 29.5%, respectively. The Mg²⁺ leaking rates were 5.3% and 3.9%, indicating higher permselectivity of the three modified membranes for Li⁺ over Mg²⁺. Among the membranes, 12CE/PEI-PDA-CR67 and 18CE/PEI-PDA-CR67 exhibited lower Li⁺ recovery efficiency and Li⁺ flux (121.5 and 109.8 mEq/s-m²) at a current density of 14.7 mA/cm² with current efficiency of 10% and 12.7%, respectively, compared to 15CE/PEI-PDA-CR67 (248.6 mEq/s·m²) with a current efficiency of 39.4%. From Table S3, the normalized Li⁺ recovery efficiency for 12CE/PEI-PDA-CR671 and 18CE/PEI-PDA-CR671, at a current density of 2.3 mA/cm², was 15.2 and 19.5 g/kWh·cm², respectively, lower than that of 15CE/PEI-PDA-CR671 (24.7 g/kWh·cm²). The conductivity reduction observed for 12CE/PEI-PDA-CR671 and 18CE/PEI-PDA-CR671 was 13.4 and 13.1%, respectively, lower than that of 15CE/PEI-PDA-CR671 (16.5%).

After an additional 4 hours of electrodialysis, the modified membranes exhibited increased Li⁺ transport permeability in Mg-rich brines. The membranes 12CE/PEI-PDA-CR671 and 18CE/PEI-PDA-CR671 showed Li recovery efficiency of 43.6% and 37.6%, respectively, which are lower than that of 15CE/PEI-PDA-CR671 (80.5%). The Li⁺ flux of 12CE/PEI-PDA-CR671 and 18CE/PEI-PDA-CR671 was 155 and 140 mEq/s·m² with current efficiency of 21.2% and 19.3%, respectively, lower than that of 15CE/PEI-PDA-CR671 (318.7 mEq/s·m²) with a higher current efficiency of 49.7%, indicating that 15CE/PEI-PDA-CR671 possessed a higher permselectivity for Li⁺ than that of 12CE/PEI-PDA-CR671 and 18CE/PEI-PDA-CR671. Similar to the Na-rich brines, modifying membranes with CE showed more persistence than pristine CR671 in Mg-rich brines.

The modified membranes exhibited distinct Li⁺ transport characteristics, and several factors influenced the permselectivity of the modified membranes containing CEs for Li⁺ and Mg²⁺. Firstly, the lower total energy of the CEs-Mg²⁺ complex (−1082.97 kJ/mol) in comparison to the CEs-Li⁺ complex (−419.19 kJ/mol) indicated the spontaneous occurrence of binding between CEs and alkali ions (e.g., Mg²⁺ and Li⁺). The stronger and more easily formed binding of CEs with Mg²⁺ instead of Li⁺ resulted in the high permselectivity of the three modified membranes for Li⁺. This observation was verified by previous FTIR analysis. Secondly, the increased hydration effect and stronger affinity of Mg²⁺ for water molecules compared to Li⁺ led to greater ease of Li⁺ transport through the membranes than Mg²⁺. Thirdly, the positively charged surface of the modified membrane from PEI induced electronic repulsion, particularly toward Mg²⁺, further contributing to the observed selectivity for Li⁺ over Mg²⁺.

### Example 27

The challenges associated with selective Li⁺ recovery from brines rich in Na⁺ or Mg²⁺ had driven intensive research toward developing selective membranes for electrodialysis. Alkali ions ligand CEs were employed to enhance the selectivity of CEM, focusing on optimizing Li⁺ recovery efficiency for the monoselective CEM (CR671) through electrodialysis. The membrane modification process involving PDA treatment and the formation of PEI-CE complexes, particularly 12CE/PEI-PDA-CR671, 15CE/PEI-PDA-CR671, and 18CE/PEI-PDA-CR671, successfully created specific channels for Li⁺ ion transport.

Characterization techniques, such as ATR-FTIR and EIS, confirmed the effective coating of CEs and the selective capacity of the membranes for Li⁺ transport in all three modified membranes. Zeta potential analysis indicated a positive surface charge in the modified membranes, with similar surface charges observed in all three. Higher water uptake was observed in the Na⁺/Li⁺ solution (3.6 mole/mole) compared to the Mg²⁺/Li⁺ solution (2.2 mole/mole) for all the modified membranes.

Bench-scale electrodialysis experiments revealed significant improvements in permselectivity and Li⁺ flux for the modified membranes during electrodialysis in Na⁺/Li⁺ solutions. At a current density of 15.9 mA/cm², 12CE/PEI-PDA-CR671 and 18CE/PEI-PDA-CR671 demonstrated significant enhancements, achieving approximately 11.9-fold and 10.4-fold improvements in permselectivity and 8.7-fold and 8.1-fold improvements in Li⁺ flux compared to PEI-PDA-CR671. In contrast, 15CE/PEI-PDA-CR671 exhibited superior higher permselectivity improvement, approximately 3.3-fold and 1.7-fold, at a lower current density of 2.3 mA/cm². Moreover, 15CE/PEI-PDA-CR671 demonstrated superior Li⁺ flux improvement, approximately 3.2-fold and 3.4-fold, at a current density of 15.9 mA/cm², surpassing the improvements seen in 12CE/PEI-PDA-CR671 and 18CE/PEI-PDA-CR671.

In Mg²⁺/Li⁺ brines, significant enhancements in Li⁺ flux were observed, reaching approximately 34-fold and 49.8-fold when comparing 12CE/PEI-PDA-CR671 and 18CE/PEI-PDA-CR671 to CR671 at a current density of 14.7 mA/cm². The membrane 15CE/PEI-PDA-CR671 also demonstrated superior permselectivity enhancements, approximately 2.4-fold and 2.7-fold, at a current density of 2.2 mA/cm². Li⁺ flux improvements were approximately 2.1-fold and 2.3-fold when compared to 12CE/PEI-PDA-CR671 and 18CE/PEI-PDA-CR671 at 14.7 mA/cm², respectively. These findings underscored the remarkable potential of 15CE-modified membranes for highly efficient Li⁺ recovery in challenging brine environments, presenting a promising avenue for further research and practical applications.

Note that in the specification and claims, “about” or “approximately” means within twenty percent (20%) of the numerical amount cited. The terms, “a”, “an”, “the”, and “said” mean “one or more” unless context explicitly dictates otherwise.

Although the invention has been described in detail with particular reference to these embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A selective membrane comprising:
a substrate;
a polyethyleneimine layer comprising a crown ether and a cross-linker;
a polydopamine layer; and
said layer of polydopamine disposed between said polyethyleneimine layer and said substrate.

2. The selective membrane of claim 1 wherein said selective membrane comprises a zeta potential of about 40 mV to about 100 mV.

3. The selective membrane of claim 1 wherein said substrate comprises a cross-linked copolymer comprising sulfonic acid functional groups.

4. The selective membrane of claim 1 further comprising an ion channel.

5. The selective membrane of claim 4 wherein said crown ether forms said ion channel.

6. The selective membrane of claim 1 wherein said crown ether comprises a 15-crown-5 ether.

7. The selective membrane of claim 1 wherein said cross-linker comprises 1,3,5-benzenetricarbonyl trichloride.

8. A method for manufacturing a selective membrane, the method comprising:
contacting a substrate with polydopamine;
forming a polydopamine layer on the surface of the substrate;
contacting the polydopamine layer with polyethyleneimine, a cross-linker, and a crown ether;
forming a polyethyleneimine layer comprising the crown ether and the cross-linker; and
forming an ion channel with the crown ether.

9. The method of claim 8 wherein the substrate comprises a cross-linked copolymer comprising sulfonic acid functional groups.

10. The method of claim 8 wherein the crown ether comprises a 15-crown-5 ether.

11. The method of claim 8 wherein the cross-linker comprises 1,3,5-benzenetricarbonyl trichloride.

12. The method of claim 8 wherein the polyethyleneimine and crown ether are attached to the cross-linker.

13. A method for selectively removing a metal ion from a solution comprising the metal ion the method comprising:
contacting the solution comprising a metal with a selective membrane, the selective membrane comprising:
a substrate;
a polyethyleneimine layer comprising a crown ether and a crosslinker; and
a polydopamine layer;
applying an electric field to the selective membrane; and
passing the metal ion through an ion channel.

14. The method of claim 13 wherein the metal ion comprises lithium.

15. The method of claim 13 wherein the metal ion comprises sodium.

16. The method of claim 13 wherein the metal ion comprises magnesium.

17. The method of claim 13 further comprising passing the metal ion through the polydopamine layer.

18. The method of claim 13 wherein the crown ether comprises a 15-crown-5 ether.

19. The method of claim 13 wherein the cross-linker comprises 1,3,5-benzenetricarbonyl trichloride.

20. The method of claim 13 wherein the ion channel is formed by the crown ether.
